(19) United States
(12) Patent Application Publication
(10) Pub. No.: US 2022/0086728 A1
(43) Pub. Date: Mar. 17, 2022

(54) NEIGHBORING CELL SIGNAL MEASUREMENT METHOD AND SYSTEM, BASE STATION, MOBILE PLATFORM, AND MEDIUM

(71) Applicant: SZ DJI TECHNOLOGY CO., LTD., Shenzhen (CN)

(72) Inventors: Zhipeng ZHANG, Shenzhen (CN); Xiaojun YIN, Shenzhen (CN); Wei FAN, Shenzhen (CN)

(21) Appl. No.: 17/456,726

(22) Filed: Nov. 29, 2021

Related U.S. Application Data
(63) Continuation of application No. PCT/CN2019/089367, filed on May 30, 2019.

(51) Int. Cl. H04W 36/32; H04W 36/00

(52) U.S. Cl. CPC H04W 36/32; H04W 36/00835

(57) ABSTRACT

A neighboring cell signal measurement method includes obtaining predictive position information of a mobile platform in a first cell, selecting a second cell from neighboring cells of the first cell according to the predictive position information to obtain a selection result, and transmitting the selection result to the mobile platform so that the mobile platform performs measurement on a signal of the second cell according to the selection result. The predictive position information includes predicted position information of the mobile platform at a period of time after a current moment.

### CROSS-REFERENCE TO RELATED APPLICATION

This application is a continuation of International Application No. PCT/CN2019/089367, filed May 30, 2019, the entire content of which is incorporated herein by reference.

### TECHNICAL FIELD

The present disclosure generally relates to the communication technology field and, more particularly, to a measurement method, a system, and a base station of a neighboring cell signal, a mobile platform, and a medium.

### BACKGROUND

In a cellular mobile communication system, by using a cellular wireless networking manner, a mobile platform and a base station are connected through a wireless channel to realize communication between mobile platforms. Due to the mobile characteristics of the mobile platform, to ensure that the mobile platform can normally communicate when crossing cells, the mobile platform needs to measure the neighboring cell signal, such that a cell with a stronger signal can be switched to or reselected.

In a related neighboring cell signal measurement manner, after the mobile platform accesses the network through a service cell, the service cell will instruct the mobile platform to perform signal measurement on a neighboring cell set of the service cell. Since frequency points of different cells may be different, correspondingly, the frequency points need to be switched when the mobile platform performs signal measurement, which causes the service of the current frequency point of the service cell to be interrupted and affects service efficiency. Moreover, the more neighboring cells on which the mobile platform performs the signal measurement, the greater the impact is. In the above manner, the mobile platform needs to perform the signal measurement on the neighboring cell set of the service cell. The measurement efficiency is low. The current frequency point service is more likely to be interrupted. The measurement has a greater impact on the service.

### SUMMARY

Embodiments of the present disclosure provide a neighboring cell signal measurement method. The method includes obtaining predictive position information of a mobile platform in a first cell, selecting a second cell from neighboring cells of the first cell according to the predictive position information to obtain a selection result, and transmitting the selection result to the mobile platform so that the mobile platform performs measurement on a signal of the second cell according to the selection result. The predictive position information includes predicted position information of the mobile platform at a period of time after a current moment.

Embodiments of the present disclosure provide a neighboring cell signal measurement method. The method includes generating predictive position information according to current positioning data of a mobile platform in a first cell of a base station, transmitting the predictive position information to the base station so that the base station selects a second cell from neighboring cells of the first cell according to the received predictive position information to obtain a selection result, obtaining the selection result transmitted by the base station, and performing measurement on a signal of the second cell according to the selection result. The predictive position information includes predicted position information of the mobile platform at a period of time after a current moment.

Embodiments of the present disclosure provide a neighboring cell signal measurement method. The method includes transmitting current positioning data of a mobile platform in a first cell to a base station associated with the first cell so that the base station generates predictive position information according to the current positioning data and selects a second cell from neighboring cells of the first cell according to the predictive position information to obtain a selection result, obtaining the selection result transmitted from the base station, and performing measurement on a signal of the second cell according to the received selection result. The predictive position information includes predicted position information of the mobile platform at a period of time after a current moment.

### BRIEF DESCRIPTION OF THE DRAWINGS

FIG. 1 is a schematic diagram of an application scenario according to some embodiments of the present disclosure.

FIG. 2 is a schematic flowchart of a neighboring cell signal measurement method according to some embodiments of the present disclosure.

FIG. 3 is a schematic diagram showing neighboring cells that need to be measured by a mobile platform according to some embodiments of the present disclosure.

FIG. 4 is a schematic diagram showing neighboring cells that needs to be measured by a mobile platform according to some embodiments of the present disclosure.

FIG. 5 is a schematic diagram showing an interaction between a base station and the mobile platform according to some embodiments of the present disclosure.

FIG. 6 is a schematic diagram showing the interaction between the base station and the mobile platform according to some other embodiments of the present disclosure.

FIG. 7 is a schematic flowchart of the neighboring cell signal measurement method according to some other embodiments of the present disclosure.

FIG. 8 is a schematic flowchart of the neighboring cell signal measurement method according to some other embodiments of the present disclosure.

### DETAILED DESCRIPTION OF THE EMBODIMENTS

The technical solutions of embodiments of the present disclosure are described clearly in connection with the accompanying drawings of embodiments of the present disclosure below. Apparently, the described embodiments are merely some embodiments of the present disclosure but not all embodiments. Based on embodiments of the present disclosure, all other embodiments obtained by those of ordinary skill in the art with creative efforts are within the scope of the present disclosure. In addition, when there is no conflict, embodiments and features of embodiments described below may be combined with each other.

Terms used in the present disclosure describe merely specific embodiments but are not intended to limit the present disclosure. The singular forms of “a,” “said,” and “the” used in the present disclosure and the appended claims are also intended to include plural forms unless the context indicates other meanings. The term “and/or” used in the present disclosure refers to and includes any or all possible combinations of one or more associated listed items.

Although the terms first, second, third, etc., may be used in the present disclosure to describe various information, the information should not be limited to these terms. These terms are used to distinguish the same type of information from each other. For example, without departing from the scope of the present disclosure, first information may also be referred to as second information, and similarly, the second information may also be referred to as the first information. Depending on the context, in addition, the used word “if” may be interpreted as “at the moment,” or “when,” or “in response to.”

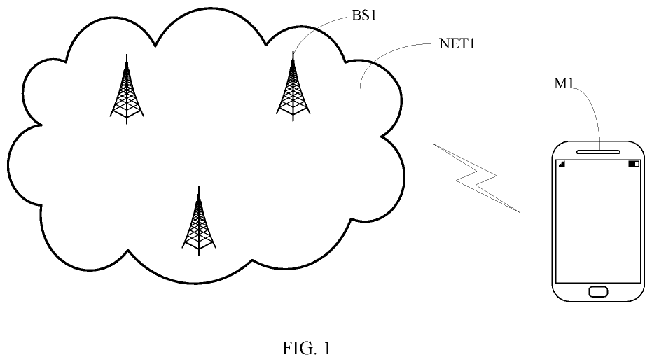

Embodiments of the present disclosure can be applied to a mobile communication scenario shown in FIG. 1. In the scenario, a cellular mobile communication network NET1 is formed by cells of a plurality of base stations BS1. When mobile platform M1 is in a cell of a certain base station, the cell may provide mobile communication service for mobile platform M1. During the movement of the mobile platform, cell crossing (i.e., crossing the boundary between two cells) may occur. In embodiments of the present disclosure, a signal measurement may be performed on neighboring cells of a current cell (i.e., the cell in which the mobile platform currently is) before the mobile platform moves to another cell. The current cell of the mobile platform is a service cell. The service cell has a plurality of neighboring cells. Edge areas of coverage areas of these neighboring cells overlap the edge area of the service cell, thereby realizing signal coverage between cells.

In embodiments of the present disclosure, the adopted cellular mobile communication network may include a 3G network, a 4G network, or a 5G network. The specific type is not limited. Correspondingly, the base station and the mobile platform may support a corresponding protocol network. The base station may include a fixed base station or a mobile base station. The specific type of the base station is not limited, as long as the base station has a function of communicating with the mobile platform.

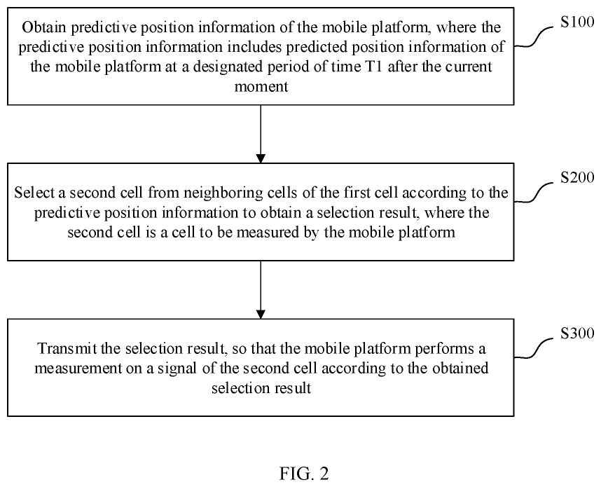

A first aspect of embodiments of the present disclosure provides a neighboring cell signal measurement method. The method may be applied to the base station. The base station is associated with a first cell where the mobile platform currently is. In some embodiments, referring to FIG. 2, the method includes obtaining predictive position information of the mobile platform, where the predictive position information includes predicted position information of the mobile platform at a designated period of time T1 after the current moment (S100); selecting a second cell from neighboring cells of the first cell according to the predictive position information to obtain a selection result, where the second cell is a cell to be measured by the mobile platform (S200); and transmitting the selection result, so that the mobile platform performs a measurement on a signal of the second cell according to the obtained selection result (S300).

In some embodiments, an execution body of the neighboring cell signal measurement method may be the base station, or a processor of the base station. The base station may include at least one cell. The mobile platform is currently in the first cell. That is, the first cell is the service cell currently used by the base station to provide services for the mobile platform.

In embodiments of the present disclosure, the mobile platform may include an unmanned aerial vehicle (UAV), or a handheld apparatus. The handheld apparatus may include, for example, a cellphone, a tablet, etc. The specific type of mobile platform is not limited. The mobile platform may further include another apparatus having a subscriber identification module (sim) card, as long as the mobile platform has a function of communicating with the base station.

Although the mobile platform is currently located in the coverage area of the first cell, the mobile platform may be currently in a moving state. Thus, the mobile platform may move to another cell after a period of time. To ensure a normal communication of the mobile platform, before moving to a certain cell, the mobile platform needs to switch to or reselect to the cell first.

Therefore, during the movement of the mobile platform, a measurement needs to be performed on the neighboring cells of the first cell. Cell reselection or switch may be performed when a certain condition is met to reselect or switch to an appropriate cell.

In process S100, the predictive position information of the mobile platform is obtained. The predictive position information includes the predicted position information of the mobile platform at the designated period of time T1 after the current moment.

The predictive position information of the mobile platform may be predicted by the mobile platform, the base station, or by a third-party apparatus, which is not limited.

Since the predictive position information is the position information of the mobile platform at a designated period of time T1 after the current moment, the position of the mobile platform at T1 after the current moment may be estimated according to the predictive position information. For example, if the current moment is t1, the position of the mobile platform at t1+T1 may be estimated according to the predictive position information.

The value of T1 is not limited. T1 may be in seconds or minutes. For example, T1 may be 10 seconds, or 1 minute, etc. In some embodiments, T1 may be determined according to a moving speed of the mobile platform. The faster the moving speed of the mobile platform is, the shorter T1 is, which is not limited.

In process S200, the second cell is selected from neighboring cells of the first cell according to the predicted position information to obtain the selection result. The second cell is a cell to be measured by the mobile platform.

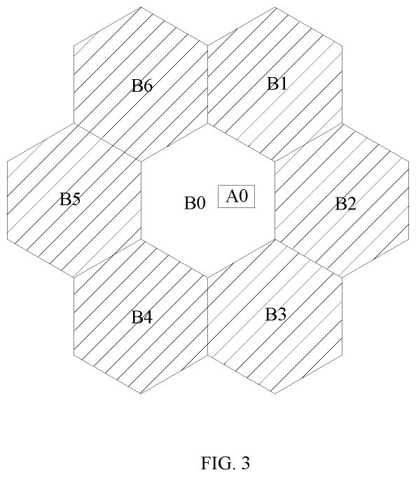

In a cellular mobile communication network, a relationship between the first cell and its neighboring cells is similar to a honeycomb shape shown in FIG. 2 and FIG. 3. The coverage areas of the two neighboring cells overlap at edges to ensure full coverage of the area of the communication network. In some embodiments, the neighboring cells may all refer to neighboring cells of the first cell.

When the base station selects the second cell from the neighboring cells of the first cell according to the predictive position information, the cell related to the predictive position information may be selected as the second cell. For example, the mobile platform at t1+T1 may be estimated according to the predictive position information. The cell having an intersection with, i.e., overlapping, this location among the neighboring cells of the first cell is used as the second cell.

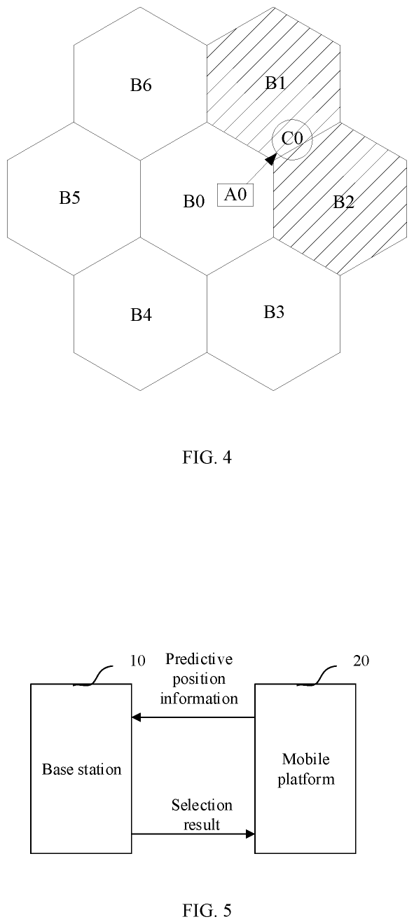

As shown in FIG. 3 and FIG. 4, B0 is the first cell, and B1-B6 are neighboring cells of the first cell. The current position of the mobile platform is A0, and the mobile platform is currently in the first cell. Referring to FIG. 3, if the predictive position information indicates that the mobile platform is at C0 at t1+T1, and C0 and the coverages of B1 and B2 are intersected. As such, when the base station selecting the second cell from the neighboring cells B1-B6 of the first cell B0 according to the predictive position information, the neighboring cells B1 and B2 may be selected as the cells to be measured, that is, the second cells.

Since the second cell is determined according to the position information of the mobile platform a period of time after the current moment, when a moving direction of the mobile platform is stable, the selected second cell is usually one or two neighboring cells of the first cell in the moving direction of the mobile platform.

In process S300, the selection result is transmitted so that the mobile platform measures the signal of the second cell according to the obtained selection result.

The selection result may indicate the second cell selected by the base station and send the selection result. For example, after transmitting the selection result to the mobile platform, the mobile platform may determine the second cell selected by the base station according to the selection result, and only perform the signal measurement on the selected second cell instead of performing the signal measurement on the neighboring cell set of the first cell, which reduces the measurement time and improve measurement efficiency.

Referring to FIG. 3, in related art, if the current position of the mobile platform is A0 and the mobile platform is currently in B0, the base station may notify the mobile platform to perform signal measurement on the set of neighboring cells B1-B6 of B0. If frequency points of B0 and B1-B6 are different, when the mobile platform performs signal measurement on neighboring cells B1-B6, 6 cell measurement times may be needed. During this period, the service of B0 needs to be interrupted, and the measurement time is relatively long, and the measurement has a greater impact on the business, that is, the quality of service between the mobile platform and the B0 is greatly impacted.

Referring to FIG. 4, in embodiments of the present disclosure, if the current position of the mobile platform is A0 and the mobile platform is currently at B0, the base station may predict a position C0 of the mobile platform at t1+T1. As such, two neighboring cells B1 and B2 may be selected from B0's neighboring cell set B1-B6, then the base station informs the mobile platform to perform signal measurement on B1 and B2. If the frequency points of B0 and B1-B6 are not the same, because signal measurement is not needed for B3-B6, when the mobile platform performs signal measurement on neighboring cells B1 and B2, only 2 periods of cell measurement time are needed. The measurement time is shorter, which reduces the resource occupation of measurement tasks and optimizes network mobility management.

In some embodiments of the present disclosure, when the mobile platform performs signal measurement on the neighboring cell of the first cell that the mobile platform is currently in, the signal measurement may not be performed on the neighboring cell set, but the base station may first obtain the position information of the mobile platform at a specified time T1 after the current time. The obtained position information is the predictive position information. According to the predictive position information, some neighboring cells related to the predictive position information are selected from the set of neighboring cells as the cell to be measured, that is, the second cell. The mobile platform may only perform a signal measurement on the second cell, which reduces the number needed to be measured and the measurement time, improves measurement efficiency, and reduces the impact of measurement on services.

In some embodiments, in process S100, obtaining predictive position information of the mobile platform includes obtaining the predictive position information at intervals of T2. T2 is shorter than T1.

T2 may be in a millisecond or second level, and the specific time is not limited. Obtaining the predicted position information every period of time T2 indicates that the operation of the base station to obtain the predicted position information and perform the selection and measurement of the second cell is performed periodically. T2 is small in an order of magnitude. T2 may be in the order of seconds or milliseconds, such that the predictive position information is updated frequently, which is beneficial to ensure the immediacy of obtaining the predictive position information.

In some embodiments, the predictive position information may be periodically obtained and the second cell selection and measurement may be performed. The predicted position information may be obtained instantly and efficiently, which may prevent the mobile platform from moving out of the first cell where it currently is before the measurement.

The predictive position information may be generated by the mobile platform and sent to the base station, and the base station may periodically obtain the predictive position information sent by the mobile platform in real-time, so as to improve the processing efficiency of the base station. The predictive position information may also be sent to the base station by other devices, or generated locally by the base station, which is not limited.

In some embodiments, the predictive position information may be generated by a device other than the base station, which may reduce the processing complexity and improve processing efficiency of the base station.

Referring to FIG. 5, a mobile platform 20 may generate its predictive position information and then transmit the predictive position information to a base station 10. The predictive position information may be generated according to the current positioning data of the mobile platform 20. Alternatively, the predictive position information may be generated from a planned moving route when the mobile platform 20 is in the process of moving under the planned route. After the base station 10 selects neighboring cells according to the predictive position information, the selection result may be sent to the mobile platform 20. The mobile platform 20 may perform the signal measurement on the selected cell.

In some embodiments, in process S100, obtaining the predictive position information of the mobile platform includes obtaining current positioning data of the mobile platform, and generating the predictive position information according to the current positioning data.

That is, the current positioning data of the mobile platform is obtained. The specific data included in the current positioning data is not limited, as long as the data can be used to determine the position information at T1 when a designated time passes after the current moment.

Then, the predictive position information is generated according to the current positioning data. The specific generation manner of the predictive position information may be determined according to the data included in the current positioning data. A corresponding calculation manner may be preset in the base station. The corresponding predictive position information may be calculated according to the current positioning data.

In some embodiments, the predictive position information may be generated based on the current positioning data of the mobile platform. The current positioning data is relatively easy to obtain. The position of the mobile platform at the designated period of time T1 after the current moment may be predicted more accurately.

In some embodiments, the current positioning data may include first position data that represents the current position of the mobile platform, the moving speed of the mobile platform, and the moving direction of the mobile platform. In these embodiments, generating the predictive position information according to the current positioning data includes determining a target position of the mobile platform according to the first position data, the moving direction of the mobile platform, and the moving speed, where the target position is a first displacement distance away from the current position in the moving position, and the first displacement distance is obtained by multiplying the moving speed and the designated time T1; and determining the predictive position information of the mobile platform according to the target position, where the predictive position information includes second position data used to represent the target position.

The current positioning data includes the first position data that represents the current position of the mobile platform, the moving speed of the mobile platform, and the moving direction of the mobile platform. This information may be obtained in a certain way during the movement of the mobile platform, such as via a positioning device. When the mobile platform is a UAV, the moving speed is the aerial speed, and the moving direction is the aerial direction.

For example, assume that the first position data representing the current position of the mobile platform is S1, the moving speed of the mobile platform is V1, and the moving direction of the mobile platform is R1. According to the speed-displacement formula, the first displacement distance D1=V1×T1. The position having a distance of D1 from S1 in direction R1 is the target position of the mobile platform. Since moving speed V1 of the mobile platform and moving direction R1 of the mobile platform are derived from the positioning data of the mobile platform, the source is reliable, which ensures that the accuracy of determining the predictive position information of the mobile platform may be improved and errors may be reduced.

Further, the predictive position information can be determined according to the target position. The predictive position information at least includes the second position data of the target position. The predictive position information may also include other information, which may be determined as needed.

For example, the first position data may include a current longitude, latitude, and altitude of the mobile platform (representing the current position of the mobile platform). Correspondingly, the second position data may include a longitude, latitude, and altitude of the mobile platform (representing the target position of the mobile platform) at the designated period of time T1 after the current moment. The first position data and the second position data are not limited here. More data dimensions may be provided to facilitate users to recognize.

In some embodiments, the target position of the mobile platform is determined according to the first position data characterizing the current position of the mobile platform, the moving speed of the mobile platform, and the moving direction of the mobile platform. Then, the predictive position information may be determined. The computational complexity is low, and the prediction results are more accurate.

In some embodiments, the position of the mobile platform at the designated period of time T1 after the current moment can be determined according to the second position data in the predictive position information. The base station may select the second cell from the neighboring cell set of the first cell according to the position.

In some embodiments, obtaining the current positioning data of the mobile platform includes obtaining current positioning data once every period time of T3. T3 is shorter than T1.

T3 may be, for example, milliseconds or seconds, and the specific time is not limited. Obtaining the predictive position information every period time of T3 indicates that the base station obtains the current positioning data and generates the predictive position information according to the current positioning data. According to this, the selection and measurement of the second cell may be performed periodically.

In some embodiments, the current positioning data is periodically obtained, and the predictive position information is generated according to the current positioning data. According to this, the selection and the measurement may be performed on the second cell, which may prevent the mobile platform from moving out of the first cell where the mobile platform currently is before the measurement and ensure a timely manner of the cell switch.

The current positioning data may be obtained by the mobile platform and transmitted to the base station. The base station may periodically obtain the current positioning data transmitted by the mobile platform in real-time. The current positioning data may also be transmitted to the base station by another apparatus, which is not limited.

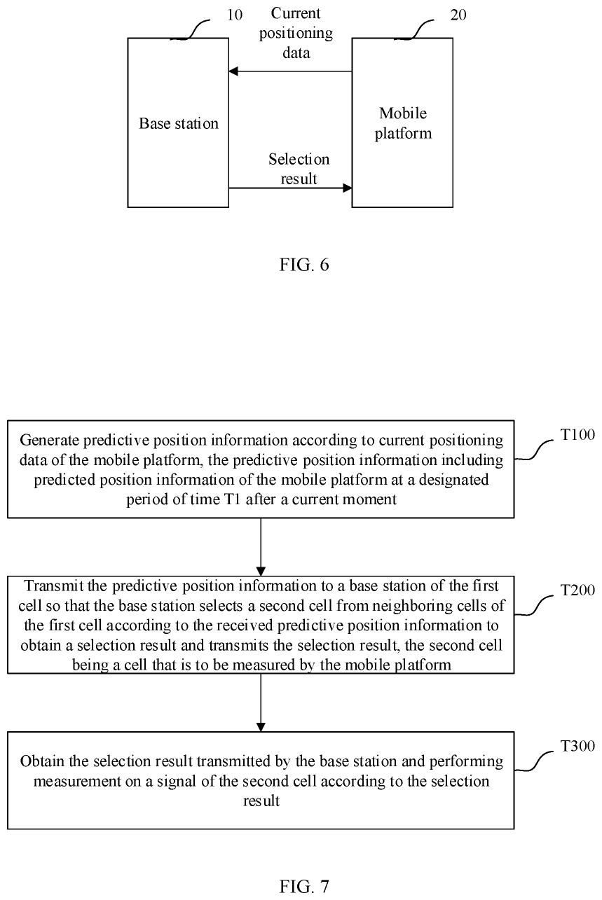

Referring to FIG. 6, the mobile platform 20 obtains its own current positioning data and transmits the current positioning data to the base station 10. The base station 10 generates the predictive position information of the mobile platform according to the current positioning data and transmits the selection result to the mobile platform 20 after selecting the neighboring cells according to the predictive position information. The mobile platform 20 performs the signal measurement on the selected cell.

In some embodiments, the current positioning data may be measured and obtained by a positioning apparatus of the mobile platform or a positioning apparatus external to the mobile platform configured to position the mobile platform.

The mobile platform may carry a positioning apparatus, which may include a global positioning system (GPS), a global navigation satellite system (GNSS), Beidou, etc. The current positioning data may be obtained by measuring the mobile platform by the carried positioning apparatus. The mobile platform may obtain its current positioning data from the carried positioning apparatus and then transmit the obtained current positioning data to the base station. In some embodiments, the current positioning data of the mobile platform may be measured by the positioning apparatus carried by the mobile platform. The positioning data may be more accurate, and the real-time characteristic of the data may also be ensured.

In some other embodiments, the current positioning data of the mobile platform may be measured by the positioning apparatus, which is external to the mobile platform and configured to position the mobile platform. The positioning apparatus may include radar, etc. The mobile platform may obtain the current positioning data from an external positioning apparatus and transmit the current positioning data to the base station. The current positioning data may be transmitted to the base station by other apparatuses.

In some embodiments, in process S200, selecting the second cell from the neighboring cells of the first cell according to the predictive position information includes predicting the target area of the mobile platform at the designated period of time T1 after the current moment according to the predictive position information, and selecting the second cell from neighboring cells of the first cell according to the target area.

The predicted position point has a certain uncertainty. Therefore, in some embodiments, the target area of the mobile platform at the designated period of time T1 after the current moment may be predicted according to the predictive position information. The target area may have a certain range, which may cover all possible positions.

In some embodiments, compared to a position point, the target area may cover all position points that the mobile platform may reach at t1+T1. The second cell may be selected from the neighboring cells of the first cell according to the target area. For example, the second cell may be selected from the neighboring cell set of the first cell according to the target area. The neighboring cell set may represent all the neighboring cells of the first cell or may represent a neighboring cell determined by the first cell, which may avoid the problem of missed or wrong selection caused by the uncertainty of a certain position point.

In some embodiments, the predictive position information may include second position data used to represent the target position and a predetermined radius.

In some embodiments, predicting the target area where the mobile platform is located at the designated period of time T1 after the current moment according to the predictive position information includes, according to the second position data and the predetermined radius, determining an area with the target position as an area center and the predetermined radius as an area radius and using the determined area as the target area.

In some embodiments, a circular area with the target position as the center and the predetermined radius as the radius may be determined according to the second position information and the predetermined radius. The circular area may be used as the target area.

The calculation manner of the second position data may be the same as the manner in the above embodiment. The predetermined radius may be determined according to a positioning error range of the positioning apparatus. The larger the error is, the larger the target area may be.

The shape of the target area and the determination manner of the target area are exemplary. The target area may also be in other shapes, such as rectangle, trapezoid, etc. Correspondingly, the determination manner of the target area may change adaptively according to its shape.

In some embodiments, the target area may be circular. The determination manner of the target area may be relatively simple. The shape of the target area may ensure that the prediction error is reduced as much as possible (the larger the target area is, the smaller the prediction error is), while the number of the neighboring cells that need to be measured is reduced as much as possible (the larger the target area is, the greater the number of the neighboring cells that need to be measured is).

In some embodiments, selecting the second cell from the neighboring cells of the first cell according to the target area includes determining the coverage area of the neighboring cell set of the first cell, and determining the second cell according to the coverage area of the neighboring cell set of the first cell and the target area.

The base station may collect the coverage area information of the neighboring cell set of the first cell in advance or collect the coverage area information of the neighboring cell set of the first cell when selecting the second cell. The coverage area may be determined according to the coverage area information of the neighboring cell set. The specific determination manner is not limited. The neighboring cell set may be a set of the neighboring cells or the neighboring cells determined by the first cell.

After the coverage area of the neighboring cell set is determined, the second cell may be determined according to the coverage area of the neighboring cells and the target area. For example, a cell with a coverage area having a largest intersection with the target area may be selected as the second cell. The specific manner is not limited.

In some embodiments, determining the coverage area of the neighboring cells of the first cell includes obtaining a coverage area information set, determining the coverage area information of the neighboring cells according to the coverage area information set as the target coverage area information of the neighboring cell set, and determining the coverage area of the neighboring cells according to the target coverage area information. The coverage area information set includes the coverage area information of the neighboring cell set of the first cell.

For each neighboring cell of the first cell, the target coverage area information of the neighboring cell may be determined from the obtained coverage area information set. The coverage area information set may include the coverage area information of all the neighboring cells of the first cell. The coverage area of the neighboring cells may be determined according to the target coverage area information.

In some embodiments, the neighboring cell set may represent all the neighboring cells of the first cell. The base station may determine the coverage area of each neighboring cell one by one collect the coverage area information of each neighboring cell in advance, and save the coverage area information of the neighboring cell set as the coverage area information set locally. When the coverage area of a neighboring cell is determined, the target coverage area information of the neighboring cell may be determined from the local coverage area information set, and the coverage area of the neighboring cell may be determined according to the target coverage area information.

In some embodiments, the coverage area information set containing the coverage area information of the neighboring cell set may be obtained in advance. When the coverage area of a neighboring cell needs to be determined, the coverage area information of the neighboring cell may be quickly obtained from the coverage area information set to quickly determine the coverage area.

In some embodiments, the target coverage area information may include third position data used to represent a center position of the neighboring cell and a cell radius.

Determining the coverage area of the neighboring cell according to the target coverage area information includes according to the third position data and the cell radius, determining an area with the center position of the neighboring cell as the area center and the cell radius as the area radius, and using the determined area as the coverage area of the neighboring cell.

According to the third position data and the cell radius, a circular area with the center position of the neighboring cell as the center and the cell radius as the radius may be determined. The circular area may be the coverage area of the neighboring cell. It can be understood that the shape of the coverage area and the determination manner of the coverage area here are all exemplary. In practical applications, the coverage area may also be in another shape.

In the cellular mobile network, the cell shape is usually circular, but some deviations may exist in practical applications. Therefore, in some embodiments, the coverage area of the neighboring cell may be determined according to the center position and the neighboring cell and the cell radius, and the processing manner may be simple.

In some embodiments, determining the second cell according to the coverage area of the neighboring cells of the first cell and the target area includes obtaining the moving direction of the mobile platform and determining the to-be-detected neighboring cell from the neighboring cells of the first cell according to the moving direction, and for each to-be-detected neighboring cell, detecting whether the coverage area of the neighboring cell has an intersection with the target area, and if yes, determining the neighboring cell that has the intersection with the target area as the second cell.

The moving direction of the mobile platform may be obtained from, for example, the current positioning data of the mobile platform. Several neighboring cells in the moving direction may be determined as the neighboring cells to be detected.

The determined neighboring cells to be detected may be detected one by one. If the coverage area of the neighboring cell has the intersection with the target area, the neighboring cell may be the cell where the mobile platform enters, the signal measurement may need to be performed, and the neighboring cell may be the second cell. If the coverage area of the neighboring cell does not have the intersection with the target area, the signal measurement may not need to be performed on the cell, and the neighboring cell may not be the second cell.

The manner of detecting whether the coverage area has the intersection with the target area is not limited. For example, when the coverage area and the target area are both circular, whether the two circles intersect may be determined. If the circles intersect with each other, the coverage area may have the intersection with the target area.

In some embodiments, some neighboring cells to be detected may be selected in advance. Each to-be-detected neighboring cell only needs to be detected whether each neighboring cell has an intersection with the target area, which reduces the processing amount required to calculate the intersection.

In some embodiments, determining the second cell according to the coverage area of the neighboring cells of the first cell and the target area includes, for each neighboring cell of the first cell, detecting whether the coverage area of the neighboring cell has an intersection with the target area, and if yes, determining the neighboring cell that has the intersection with the target area as the second cell.

In some embodiments, the neighboring cell set may be detected one by one. If a coverage area of a neighboring cell has an intersection with the target area, the neighboring cell may be a cell that the mobile platform may enter. The signal measurement may need to be performed. The neighboring cell may be the second cell. If the coverage area of the neighboring cell does not have the intersection with the target area, the signal measurement does not need to be performed on the cell. The neighboring cell may not be the second cell.

In some embodiments, by detecting whether each neighboring cell has an intersection with the target area, a full detection rate may be ensured, which may avoid an omission of a neighboring cell that should be determined as the second cell.

In some embodiments, the selection result may include a target cell information set. The target cell information set may include cell information of the second cells.

Before transmitting the selection result, the method further includes obtaining the cell information of the second cells from an obtained initial cell information set, the initial cell information set including cell information of the neighboring cell set of the first cell; and combining the obtained cell information of the second cells into the target cell information set.

The base station may pre-collect the cell information of the neighboring cells of the first cell and store the collected cell information as a set locally, obtain the cell information of the second cells from the local set, and then transmit the cell information of the second cells as the target cell information set to the mobile platform.

In some embodiments, the initial cell information set including the cell information of the neighboring cell set may be obtained in advance. After the second cell is determined, the cell information of the second cells may be quickly obtained from the initial cell information set. The cell information of the second cells may be transmitted to the mobile platform as the target cell information set, which avoids affecting the real-time performance of the measurement.

In some embodiments, the cell information may include at least a cell identity and a cell frequency point.

The cell identity may uniquely characterize the cell. The mobile platform may determine a corresponding cell according to the cell identity. After receiving the target cell information set, the mobile platform may determine the second cell according to the cell identity of the second cell in the set.

The cell frequency may be a frequency for communicating with the cell. The mobile platform may perform the measurement on the signal of the second cell at the cell frequency of the second cell.

In some embodiments, an operation of determining the second cell and performing the measurement on the second cell may have already been completed based on the cell identity and cell frequency, which reduces data amount that the base station needs to send to the mobile platform and reduces transmission time.

The cell information may also include other information, which is not limited.

In some embodiments, performing the measurement on the signal of the second cell by the mobile platform according to the obtained selection result includes the mobile platform determining the second cell according to the obtained selection result and performing the measurement on the signal of the second cell.

For example, the second cell may be determined according to the cell identity in the selection result, and then the signal measurement may be performed according to the cell frequency of the second cell to measure a reference signal of the second cell. The specific signal measurement manner is not limited.

In some embodiments, after transmitting the selection result, the method further includes obtaining current measurement results of the second cells obtained by the mobile platform by measuring the signals of the second cells and determining whether the mobile platform needs to perform cell switch according to the current measurement results.

In some embodiments, after the signal measurement is performed on each second cell, the current measurement result of the second cell may be obtained. The current measurement result may include, for example, information such as a signal strength of the second cell at the current position of the mobile platform.

In some embodiments, whether the mobile platform needs to perform the cell switch may be determined according to the current measurement result. For example, if a signal strength contained in one of the current measurement results reaches a predetermined signal strength, determining that the mobile platform needs to perform the cell switch. In some embodiments, the mobile platform may switch to a second cell with the strongest signal strength.

In some embodiments, the current measurement result may indicate the signal condition of the second cell at the current position of the mobile platform. Based on this, whether the mobile platform needs to perform the cell switch may be determined.

In some embodiments, determining whether the mobile platform needs to perform the cell switch according to the current measurement result includes traversing the current measurement results of the second cells; detecting whether the signal strengths in the traversed current measurement result reaches the predetermined signal strength; and if yes, obtaining N consecutive historical measurement results of the second cells measured before the mobile platform traverses the current measurement results, where N is greater than or equal to 1, obtaining a number of times when the signal strengths in the N consecutive historical measurement results reach the predetermined signal strength, and determining whether the number of times when the signal strengths in the N consecutive historical measurement results reach the predetermined signal strength reaches a reference value, and if yes, determining that cell switch needs to be performed for the mobile platform.

In some embodiments, the current measurement results of the second cells may be traversed in a predetermined traversal manner (for example, a tree traversal manner, which depends on a data structure manner of the current measurement results in the base station).

The current measurement result may include the signal strength of the second cell at the current position of the mobile platform. In some embodiments, whether the signal strength of the current measurement result traversed reaches the predetermined signal strength is detected. The predetermined signal strength may be determined according to the signal strength required for communication, for example, a lowest signal strength that satisfies the communication condition, which is not limited.

In some embodiments, if the signal strength of the current measurement result traversed reaches the predetermined signal strength, the N consecutive historical measurement results of the mobile platform may be obtained. The N consecutive historical measurement results may be measurement results measured and obtained before the current measurement result is traversed. Whether the signal strengths of the historical measurement results reach the predetermined signal strength may be detected, and a number of times when the signal strengths of the historical measurement results reach the predetermined signal strength may be accumulated. If the number of times reaches reference value RF1, it indicates that, in a short period of time, for at least RF1+1 times, the mobile platform has measured that the signal strength of the second cell has reached the predetermined signal strength. The cell switch may need to be performed. Otherwise, the cell switch may not need to be performed.

The value of N and the reference value are not limited. The reference value may be less than or equal to N. In some embodiments, the reference value may be equal to N, which means that the mobile platform has continuously measured that the signal strength of the second cell reaches the preset strength for N+1 times, and the cell switch may be performed.

In some embodiments, when the mobile platform measures that the signal strength of the second cell reaches the predetermined signal strength for at least RF1+1 times in the short period of time, then the mobile platform determines that the cell switch needs to be performed, which avoids an unstable signal of the second cell and a fault switch caused when the signal strength reaches the predetermined signal strength at only a certain time.

In some embodiments, the method further includes if the signal strength in the current measurement result of the second cell traversed reaches the predetermined signal strength, and all the signal strengths in the historical measurement results of the second cell are detected to reach the predetermined signal strength, determining that the mobile platform needs to perform the cell switch.

In other words, if the signal strength in the current measurement result of the traversed second cell reaches the predetermined signal strength, the N consecutive historical measurement results of the mobile platform may be obtained. The N consecutive historical measurement results may be measured and obtained before the current measurement result is traversed.

Whether the signal strengths in the historical measurement results reach the predetermined signal strength may be detected. If all the detected signal strengths in the historical measurement results of the second cell reach the predetermined signal strength, that is, the number of times reaches N times, the mobile platform may be determined to need to perform the cell switch.

In some embodiments, when the mobile platform measures at least N+1 times in a short period of time that the signal strength of the second cell reaches the predetermined signal strength, the cell switch may be determined to be performed, which further avoids the unstable signal of the second cell and a fault switch caused when the signal strength reaches the predetermined signal strength at only a certain time.

In some embodiments, after determining that the mobile platform needs to perform the cell switch, the method further includes determining the second cell where the number of times reaches the reference value when the signal strengths in the N consecutive historical measurement results reach the predetermined signal strength and switching the mobile platform from the first cell to the determined second cell.

In some embodiments, the second cell where the number of times reaches the reference value when signal strengths in N consecutive historical measurement results reach the predetermined signal strength may be used as the cell to which the mobile platform needs to switch. Thus, the mobile platform may be ensured to switch to the cell of continuously and stably maintaining a relatively strong signal status, which avoids the problems of switching to a cell with an unstable or weak signal.

The above is an expanded description of the neighboring cell signal measurement method as shown in FIG. 2 provided by a first aspect of embodiments of the present disclosure. In some embodiments, the position information of the mobile platform at the designated period of time T1 after the current moment obtained by the base station is the predictive position information. Some neighboring cells related to the predictive position information may be selected from the neighboring cell set according to the predictive position information as the second cells, which realizes the selection of the to-be-measured cell. The mobile platform may only need to perform the signal measurement on the second cells, which reduces the number of cells that need to be measured and the measurement time, improves the measurement efficiency, and reduces the impact of the measurement on the business.

A second aspect of the present disclosure provides a neighboring cell signal measurement method, which may be applied to the mobile platform. The mobile platform may be configured to be in the first cell. In some embodiments, referring to FIG. 7, the method includes generating predictive position information according to current positioning data of the mobile platform, the predictive position information including predicted position information of the mobile platform at a designated period of time T1 after a current moment (T100), transmitting the predictive position information to a base station of the first cell so that the base station selects a second cell from neighboring cells of the first cell according to the received predictive position information to obtain a selection result and transmits the selection result, the second cell being a cell that is to be measured by the mobile platform (T200), and obtaining the selection result transmitted by the base station and performing measurement on a signal of the second cell according to the selection result (T300).

The execution body of the neighboring cell signal measurement method of some embodiments may be the mobile platform, or a processor of the mobile platform. The mobile platform may currently be in the first cell of the base station. That is, the first cell is a service cell currently used by the base station to provide services for the mobile platform.

In some embodiments, as shown in FIG. 5, the mobile platform 20 transmits the predictive position information to the base station 10. The base station 10 selects the second cell based on the predictive position information and then transmits the selection result. For example, the selection result is transmitted to the mobile platform 20. The mobile platform 20 may perform the signal measurement on the second cell according to the selection result.

The mobile platform may be a UAV or a handheld apparatus. The handheld apparatus may include, for example, a cellphone, a tablet, etc. The specific type of mobile platform is not limited. The mobile platform may further include another apparatus having a subscriber identification module (sim) card, as long as the mobile platform has a function of communicating with the base station.

Although the mobile platform is currently located in the coverage area of the first cell, the mobile platform may be currently in a moving state. Thus, the mobile platform may move to another cell after a period of time. To ensure a normal communication of the mobile platform, before moving to a certain cell, the mobile platform needs to switch to or reselect to the cell first.

Therefore, during the movement of the mobile platform, the measurement needs to be performed on the neighboring cells of the first cell. Cell reselection or switch may be performed when a certain condition is met to reselect or switch to an appropriate cell.

In process T100, the predictive position information is generated according to the current positioning data of the mobile platform. The generation manner of the predictive position information may be determined according to the data included in the current positioning data. A corresponding calculation manner may be preset in the mobile platform. The corresponding predictive position information may be calculated according to the current positioning data.

In some embodiments, the predictive position information may be generated by the mobile platform not the base station, which may reduce the processing complexity and processing efficiency of the base station.

In process T200, the predictive position information may be transmitted to the base station of the first cell so that the base station may select the second cell from the neighboring cells of the first cell according to the received predictive position information and transmit the selection result.

Since the predictive position information is the position information of the mobile platform at the designated period of time T1 after the current time, the position where the mobile platform is located at the designated period of time T1 after the current moment according to the predictive position information. For example, when the current moment is t1, the position of the mobile platform at t1+T1 may be estimated according to the predictive position information.

The value of T1 may not be limited and may be in seconds or minutes, for example, 10 seconds, 1 minute, etc. In some embodiments, T1 may be determined according to the moving speed of the mobile platform. The faster the moving speed of the mobile platform is, the shorter T1 may be, which is not a limitation.

When the base station selects the second cell from the neighboring cells of the first cell according to the predictive position information, the cell related to the predictive position information may be selected as the second cell. For example, the position of the mobile platform at t1+T1 may be estimated according to the predictive position information. The cell having an intersection with the position in the neighboring cells of the first cell may be used as the second cell. The base station may transmit the selection result, for example, if the selection result is transmitted to the mobile platform, and the selection result may indicate the selected second cell.

In process T300, the selection result transmitted by the base station is obtained, and the measurement is performed on the signal of the second cell according to the obtained selection result.

The mobile platform may receive the selection result transmitted by the base station and determine the second cell selected by the base station according to the selection result. The mobile platform may only perform the signal measurement on the selected second cell and no longer perform the signal measurement on the neighboring cell set of the first cell.

In some embodiments, the current positioning data may include first position data that represents the current position of the mobile platform, the moving speed of the mobile platform, and the moving direction of the mobile platform. This information may be obtained through certain channels during the movement of the mobile platform, for example, via a positioning apparatus. When the mobile platform is a UAV, the moving speed is the aerial speed, and the moving direction is the aerial direction.

In some embodiments, in process T100, generating the predictive position information according to the current positioning data of the mobile platform includes determining a target position of the mobile platform according to the first position data, the moving direction of the mobile platform, and the moving speed, where the target position is a first displacement distance away from the current position in the moving position, and the first displacement distance is obtained by multiplying the moving speed and the designated time T1; and determining the predictive position information of the mobile platform according to the target position, the predictive position information including second position data used to represent the target position.

Assume that the first position data representing the current position of the mobile platform is S1, the moving speed of the mobile platform is V1, and the moving direction of the mobile platform is R1. According to the speed-displacement formula, the first displacement distance D1=V1×T1. The position having a distance of D1 from S1 in direction R1 is the target position of the mobile platform. Since moving speed V1 of the mobile platform and moving direction R1 of the mobile platform are derived from the positioning data of the mobile platform, the source is reliable, which ensures that the accuracy of determining the predictive position information of the mobile platform may be improved, and errors may be reduced.

The first position data may include a current longitude, latitude, and altitude of the mobile platform (representing the current position of the mobile platform). Correspondingly, the second position data may include a longitude, latitude, and altitude of the mobile platform (representing the target position of the mobile platform) at the designated period of time T1 after the current moment. The first position data and the second position data are not limited here.

In some embodiments, the mobile platform may predict the predictive position information once every period of time T2 and transmit the predicted and obtained predictive position information to the base station. T2 may be shorter than T1.

T2 may be in a millisecond or second level. The mobile platform may periodically transmit the predictive position information so that the base station may periodically select and measure the second cell, which may prevent the mobile platform from moving out of the first cell where the mobile platform currently is before the measurement. T2 may be small in an order of magnitude. T2 may be in the order of and seconds or milliseconds, such that the predictive position information may be updated frequently, which is beneficial for the real-time performance of obtaining the predictive position information.

In some embodiments, the predictive position information may be generated and transmitted to the base station by the mobile platform instead of being completed by the base station, which may reduce the processing complexity and processing efficiency of the base station.

In some embodiments, the current positioning data may be measured and obtained by a positioning apparatus on the mobile platform or a positioning apparatus external to the mobile platform for positioning the mobile platform.

The mobile platform may carry a positioning apparatus, which may include the GPS, the GNSS, the Beidou, etc. The current positioning data may be obtained by measuring the mobile platform by the carried positioning apparatus. The mobile platform may obtain its current positioning data from the carried positioning apparatus and then transmit the obtained current positioning data to the base station.

In some other embodiments, the current positioning data of the mobile platform may be measured by the positioning apparatus, which is external to the mobile platform and configured to position the mobile platform. The positioning apparatus may include radar, etc. The mobile platform may obtain the current positioning data from an external positioning apparatus and transmit the current positioning data to the base station. The current positioning data may be transmitted to the base station by other apparatuses.

In some embodiments, the selection result may include a target cell information set. The target cell information set may include cell information of the second cells.

In process T300, performing the measurement on the signal of the second cell according to the obtained selection result includes performing the measurement on the neighboring cell signal in the neighboring cell set of the first cell corresponding to the cell information in the target cell information.

The cell information in the target cell information set may characterize the second cell selected by the base station. Therefore, the measurement may be performed on the neighboring cell signal corresponding to each piece of cell information in the target cell information set to realize the measurement of the signals of all the second cells.

In some embodiments, the cell information may include at least a cell identity and a cell frequency point.

The cell identity may uniquely characterize the cell. The mobile platform may determine a corresponding cell according to the cell identity. After receiving the target cell information set, the mobile platform may determine the second cell according to the cell identity of the second cell in the set.

The cell frequency point may be a frequency for communicating with the cell. The mobile platform may perform the measurement on the signal of the second cell at the cell frequency point of the second cell.

The cell information may also include other information, which is not limited.

In some embodiments, in process T300, performing the measurement on the signals of the second cells according to the obtained selection result includes determining the second cell according to the obtained selection result and performing the measurement on the signal of the second cell.

For example, the second cell may be determined according to the cell identity in the selection result, and then the signal measurement may be performed according to the cell frequency point of the second cell to measure the reference signal of the second cell. The specific signal measurement method is not limited.

In some embodiments, after performing the measurement on the signal of the second cell according to the obtained selection result, the method further includes transmitting the current measurement results of the second cells obtained by measuring the signals of the second cells to the base station so that the base station determines whether the mobile platform needs to perform the cell switch.

The current measurement result of each second cell may include the signal strength of the second cell at the current position of the mobile platform, or other information, which is not limited in detail.

The above is an expanded description of the neighboring cell signal measurement method as shown in FIG. 7 provided by the second aspect of embodiments of the present disclosure. In some embodiments, the mobile platform may transmit the position information of the mobile platform at the designated period of time T1 the current moment to the base station. Thus, the base station may select some neighboring cells related to the predictive position information from the neighboring cell set as the second cell according to the predictive position information, which realizes the selection of the to-be-measured cell. The mobile platform may only need to perform the signal measurement on the second cell, which reduces the number of cells to be measured and the measurement time, improves the measurement efficiency, and reduces the impact of measurement on the business.

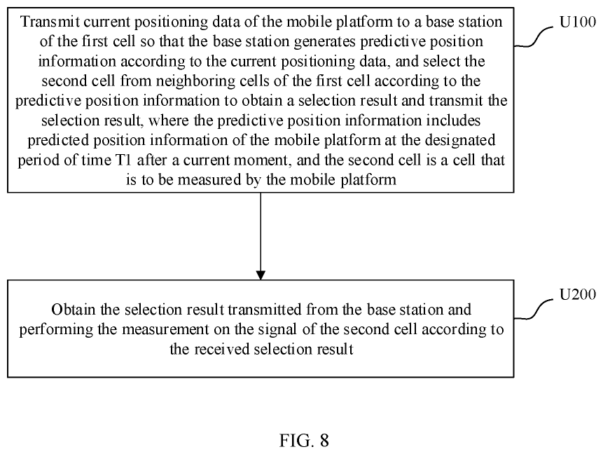

A third aspect of the present disclosure also provides a neighboring cell signal measurement method, which is applied to the mobile platform. The mobile platform may be configured to be currently in a first cell. In some embodiments, referring to FIG. 8, the method includes transmitting current positioning data of the mobile platform to a base station of the first cell so that the base station generates predictive position information according to the current positioning data, and selecting the second cell from neighboring cells of the first cell according to the predictive position information to obtain a selection result and transmit the selection result, where the predictive position information includes predicted position information of the mobile platform at the designated period of time T1 after a current moment, and the second cell is a cell that is to be measured by the mobile platform (U100), and obtaining the selection result transmitted from the base station and performing the measurement on the signal of the second cell according to the received selection result (U200).

The execution body of the neighboring cell signal measurement method of some embodiments may be the mobile platform or a processor of the mobile platform. The mobile platform may currently be in the first cell of the base station. That is, the first cell may be the service cell currently used by the base station to provide services for the mobile platform.

In some embodiments, as shown in FIG. 6, the mobile platform 20 transmits the current positioning data to the base station 10. The base station 10 generates the predictive position information according to the current positioning data, selects the second cell according to the predictive position information, and then transmits the selection result to the mobile platform 20. The mobile platform 20 may perform the signal measurement on the second cell according to the selection result.

The mobile platform may be a UAV or a handheld apparatus. The handheld apparatus may include, for example, a cellphone, a tablet, etc. The specific type of mobile platform is not limited. The mobile platform may further include another apparatus having a subscriber identification module (sim) card, as long as the mobile platform has a function of communicating with the base station.

Although the mobile platform is currently located in the coverage area of the first cell, the mobile platform may be currently in a moving state. Thus, the mobile platform may move to another cell after a period of time. For maintaining a normal communication of the mobile platform, before moving to a certain cell, the mobile platform needs to switch to or reselect to the cell first.

Therefore, during the movement of the mobile platform, the measurement may need to be performed on the neighboring cells of the first cell. The cell reselection or switch may be performed when a certain condition is met to reselect or switch to an appropriate cell.

In process U100, the current positioning data of the mobile platform is transmitted to the base station of the first cell. The specific data contained in the current positioning data is not limited, as long as the data can be used to determine the position information at the designated period of time T1 after the current moment.

After obtaining the current positioning data transmitted by the mobile platform, the base station may generate the predictive position information according to the current positioning data and select the second cell from the neighboring cells of the first cell according to the predictive position information to obtain the selection result and transmit the selection result.

The specific generation manner of the predictive position information may be determined according to the data contained in the current positioning data. The corresponding calculation manner can be preset in the base station. The corresponding predictive position information may be calculated according to the current positioning data.

Since the predictive position information is the position information of the mobile platform at the designated period of time T1 after the current moment, the position where the mobile platform is located at T1 after the current moment may be estimated according to the predictive position information. For example, when the current moment is t1, the position of the mobile platform at t1+T1 may be estimated based on the predictive position information.

The value of T1 is not limited and may be in seconds or minutes, for example, 10 seconds, 1 minute, and etc. In some embodiments, T1 may be determined according to the moving speed of the mobile platform. The faster the moving speed of the mobile platform is, the shorter T1 may be, which is not limited here.

In the cellular mobile communication network, the relationship between the first cell and its neighboring cells is similar to the honeycomb shape in FIG. 2 and FIG. 3. The coverage areas of the two neighboring cells overlap at the edges to ensure the full coverage of the communication network. In some embodiments, the neighboring cells may all refer to neighboring cells of the first cell.

When the second cell is selected from the neighboring cells of the first cell according to the predictive position information, the cell related to the predictive position information may be selected as the second cell. For example, the position of the mobile platform may be estimated at t1+T1 according to the predictive position information. The cell having an intersection with the position in the neighboring cells of the first cell may be used as the second cell. The base station may transmit the selection result to the mobile platform. The selection result may indicate the selected second cell.

In process U200, the selection result transmitted from the base station is obtained, and the measurement is performed on the signal of the second cell according to the obtained selection result.

The mobile platform may receive the selection result transmitted by the base station and determine the second cell selected by the base station according to the selection result. The mobile platform may only perform the signal measurement on the selected second cell and no longer performs the signal measurement on the neighboring cells of the first cell.

In some embodiments, transmitting the current positioning data of the mobile platform to the base station of the first cell includes transmitting the current positioning data once every period of time T3, T3 being shorter than T1.

T3 may be, for example, milliseconds or seconds. The mobile platform may periodically transmit the current positioning data to the base station so that the base station may periodically generate the predictive position information according to the current positioning data and perform the selection and measurement on the second cell, which prevents the mobile platform from moving out of the first cell where the mobile platform currently is before the measurement.

Referring to FIG. 6, the mobile platform 20 obtains its own current positioning data and transmits the current positioning data to the base station 10. The base station 10 generates the predictive position information of the mobile platform according to the current positioning data and transmits the selection result to the mobile platform 20 after selecting the neighboring cells according to the predictive position information. The mobile platform 20 performs the signal measurement on the selected cell.

In some embodiments, the current positioning data may be measured and obtained by the positioning apparatus of the mobile platform, or the current positioning data may be measured and obtained by a positioning apparatus external to the mobile platform and configured to position the mobile platform.

The mobile platform may carry a positioning apparatus, which may include the GPS, the GNSS, the Beidou, etc. The current positioning data may be obtained by measuring the mobile platform by the carried positioning apparatus. The mobile platform may obtain its current positioning data from the carried positioning apparatus and then transmit the obtained current positioning data to the base station.

In some other embodiments, the current positioning data of the mobile platform may be measured by the positioning apparatus, which is external to the mobile platform and configured to position the mobile platform. The positioning apparatus may include radar, etc. The mobile platform may obtain the current positioning data from an external positioning apparatus and transmit the current positioning data to the base station. The current positioning data may be transmitted to the base station by other apparatuses.

In some embodiments, the selection result may include a target cell information set. The target cell information set may include cell information of the second cells.

In process U200, performing the measurement on the signal of the second cell according to the obtained selection result includes performing the measurement on the neighboring cell signal in the neighboring cell set of the first cell corresponding to the cell information in the target cell information set.

The cell information in the target cell information set may represent the second cell selected by the base station. Therefore, the measurement may be performed on the neighboring cell signal corresponding to each piece of cell information in the target cell information set to realize the measurement of the signals of all the second cells.

In some embodiments, the cell information includes at least the cell identity and the cell frequency point.

The cell identity may uniquely characterize the cell. The mobile platform may determine a corresponding cell according to the cell identity. After receiving the target cell information set, the mobile platform may determine the second cell according to the cell identity of the second cell in the set.

The cell frequency point may be a frequency for communicating with the cell. The mobile platform may perform the measurement on the signal of the second cell at the cell frequency point of the second cell.

The cell information may also include other information, which is not limited.

In some embodiments, in process U200, performing the measurement on the signal of the second cell according to the obtained selection result includes determining the second cell according to the obtained selection result and performing the measurement on the signal of the second cell.

For example, the second cell may be determined according to the cell identity in the selection result, and then the signal measurement may be performed according to the cell frequency point of the second cell. The reference signal of the second cell may be measured. The specific signal measurement manner is not limited.

In some embodiments, after performing the measurement on the signal of the second cell according to the obtained selection result, the method further includes transmitting the current measurement results of the second cells obtained by measuring the signal of each second cell to the base station so that the base station determines whether the mobile platform needs to perform the cell switch according to the current measurement result (U300).

The current measurement result of each second cell may include the signal strength of the second cell at the current position of the mobile platform, or other information, which is not limited.

The above is an expanded description of the neighboring cell signal measurement method as shown in FIG. 8 provided by the third aspect of embodiments of the present disclosure. In some embodiments, the mobile platform transmits the current positioning data of the mobile platform to the base station to cause the base station to, according to the current positioning data, generate the position information when the designated period of time passes after the current moment that is the predictive position information and transmit to the base station, and select some neighboring cells related to the predictive position information from the neighboring cell set as the second cells, which realizes the selection of the to-be-measured cell. The mobile platform may only need to perform the signal measurement on the second cell, which reduces the number of cells to be measured and the measurement time, improves the measurement efficiency, and reduces the impact of measurement on the business.

A fourth aspect of the present disclosure provides a base station. The base station may be associated with a first cell where a mobile platform currently is.

The base station includes one or more processors, which are configured to obtain predictive position information of the mobile platform, where the predictive position information includes predicted position information of the mobile platform at a designated period of time T1 after a current moment, select a second cell from neighboring cells of the first cell according to the predictive position information to obtain a selection result, where the second cell is a cell that is to be measured by the mobile platform, and transmit the selection result to the mobile platform so that the mobile platform performs measurement on a signal of the second cell according to the selection result.

In some embodiments, when obtaining the predictive position information of the mobile platform, the processor is configured to obtain the predictive position information once every period of time T2, T2 being shorter than T1.

In some embodiments, when obtaining the predicted position information of the mobile platform, the processor is configured to obtain the current positioning data of the mobile platform, and according to the current positioning data, generate the predictive position information.

In some embodiments, the current positioning data may include first position data that represents the current position of the mobile platform, the moving speed of the mobile platform, and the moving direction of the mobile platform.

When generating the predictive position information according to the current positioning data, the processor is configured to determine the target position of the mobile platform according to the first position data, the moving direction of the mobile platform, and the moving speed of the mobile platform, where the target position has a first displacement distance away from the current position in the moving direction, and the first displacement distance is obtained by multiplying the movement speed and the designated time T1 and according to the target position, determine the predictive position information of the mobile platform, where the predictive position information includes second position data used to characterize the target position.

In some embodiments, when obtaining the current positioning data of the mobile platform, the processor is configured to obtain the current positioning data every period of time T3, T3 being shorter than T1.

In some embodiments, the current positioning data may be measured and obtained by a positioning apparatus of the mobile platform, or the current positioning data may be measured and obtained by a positioning apparatus external to the mobile platform and configured to position the mobile platform.

In some embodiments, when selecting the second cell from the neighboring cells of the first cell according to the predictive position information, the processor is configured to predict, according to the predictive position information, a target area where the mobile platform is located at the designated period of time T1 after the current moment and select the second cell from the neighboring cells of the first cell according to the target area.

In some embodiments, the predictive position information may include the second position data used to characterize the target position and a predetermined radius.

When predicting the target area where the mobile platform is located at the designated period of time T1 after the current moment according to the predictive position information, the processor is configured to according to the second position data and the predetermined radius, determine an area with the target position as the area center and the predetermined radius as the area radius, and use the determined area as the target area.

In some embodiments, when selecting the second cell from the neighboring cells of the first cell according to the target area, the processor is configured to determine the coverage area of the neighboring cell set of the first cell and according to the coverage area of the neighboring cell set of the first cell and the target area, determine the second cell.

In some embodiments, when determining the coverage area of the neighboring cells of the first cell, the processor is configured to obtain a coverage area information set, where the coverage area information set includes the coverage area information of the neighboring cell set of the first cell; determine the coverage area information of the neighboring cell according to the coverage area information set as the target coverage area information; and determine the coverage area of the neighboring cell according to the target coverage area information.

For each neighboring cell of the first cell, the target coverage area information of the neighboring cell may be determined from the obtained coverage area information set. The coverage area information set may include the coverage area information of the neighboring cell set of the first cell. The coverage area of the neighboring cell may be determined according to the target coverage area information.

In some embodiments, the target coverage area information may include third position data used to characterize the center position of the neighboring cell and a cell radius.

When determining the coverage area of the neighboring cell according to the target coverage area information, the processor is configured to according to the third position data and the cell radius, determine an area with the center position of the neighboring cell as the center of the area and the cell radius as the area radius and use the determined area as the coverage area of the neighboring cell.

In some embodiments, when determining the second cell according to the coverage area of neighboring cells of the first cell and the target area, the processor is configured to obtain the moving direction of the mobile platform and determine the to be detected neighboring cell from the neighboring cells of the first cell according to the moving direction and for each to be detected neighboring cell, detect whether the coverage area of the neighboring cell has an intersection with the target area, and if yes, determine the neighboring cell that has the intersection with the target area as the second cell.

In some embodiments, when determining the second cell according to the coverage area of the neighboring cells of the first cell and the target area, the processor is configured to for each neighboring cell in the neighboring cell set of the first cell, detect whether the coverage area of each neighboring cell has an intersection with the target area, if yes, determine the neighboring cell that has the intersection with the target area as the second cell.

In one embodiment, the selection result may include the target cell information set. For obtaining the selection result, the target cell information set may include the cell information of the second cells.

Before transmitting the selection result, the processor is further configured to obtain the cell information of the second cells from the obtained initial cell information set, where the initial cell information set includes the cell information of the neighboring cell set of the first cell and form the obtained cell information of the second cells into the target cell information set.

In some embodiments, the cell information may include at least a cell identity and a cell frequency point.

In some embodiments, the mobile platform performing the measurement on the signal of the second cell according to the obtained selection result includes the mobile platform determining the second cell according to the obtained selection result and performing the measurement on the signal of the second cell.

In some embodiments, after transmitting the selection result, the processor is further configured to obtain the current measurement results of the second cells obtained by performing the measurement on the signals of the second cells by the mobile platform and determine whether the mobile platform needs to perform the cell switch according to the current measurement result.

In some embodiments, when determining whether the mobile platform needs to perform the cell switch according to the current measurement result, the processor is configured to:

traverse the current measurement results of the second cells;

detect whether the signal strengths in the traversed current measurement result reaches the predetermined signal strength; and

if yes, obtain N consecutive historical measurement results of the second cells measured and obtained before the mobile platform traverses the current measurement result, where N is greater than or equal to 1, obtain a number of times that the signal strengths in the N consecutive historical measurement results reach the predetermined signal strength, and determine whether the number of times when the signal strengths in the N consecutive historical measurement results reach the predetermined signal strength reaches a reference value, and if yes, determine that the mobile platform needs to perform the cell switch.

In some embodiments, the processor may be further configured to if the signal strengths in the traversed current measurement result of the second cell reach the predetermined signal strength, and all the signal strengths in the historical measurement results of the second cell are detected to reach the predetermined signal strength, determine that the mobile platform needs to perform the cell switch.

In some embodiments, after determining that the mobile platform needs to perform the cell switch, the processor is further configured to determine the second cell where the number of times that the signal strengths in the N consecutive historical measurement results reach the predetermined signal strength reaches the reference value and switch the mobile platform from the first cell to the determined second cell.

In some embodiments, the mobile platform may include the UAV or the handheld apparatus.

For the specific content of the base station provided by the fourth aspect of the present disclosure, reference may be made to the related description in the neighboring cell signal measurement method provided by the first aspect of the present disclosure. The similarities are not repeated here.

A fifth aspect of the present disclosure provides a mobile platform, which is configured to be currently in a first cell of a base station.

The mobile platform includes a body, a power system, and one or more processors. The power system is configured to provide power to the body. The one or more processors are configured to generate predictive position information according to current positioning data of the mobile platform, where the predictive position information includes predicted position information of the mobile platform at a designated period of time T1 after a current moment, transmit the predictive position information to a base station of the first cell so that the base station selects a second cell from neighboring cells of the first cell according to the received predictive position information to obtain a selection result and transmit the selection result, where the second cell is a cell that is to be measured by the mobile platform, and obtain the selection result transmitted by the base station and perform measurement on a signal of the second cell according to the selection result.

In some embodiments, the mobile platform may include a UAV, or a handheld apparatus. The handheld apparatus may include, for example, a cellphone, a tablet, etc. The specific type of mobile platform is not limited. The mobile platform may further include another apparatus having a sim card, as long as the mobile platform have a function of communicating with the base station.

For example, the mobile platform may be the UAV. The body may be a UAV body. The power system may include a power source, a motor, and a propeller of the mobile platform. For another example, the mobile platform may be a cellphone. The body may be a cellphone body. The power system may be a power source on the mobile phone, and so on.

In some embodiments, the current positioning data may include first position data that represents the current position of the mobile platform, the moving speed of the mobile platform, and the moving direction of the mobile platform.

In some embodiments, when generating the predictive position information according to the current positioning data of the mobile platform, the processor is configured to determine the target position of the mobile platform according to the first position data, the moving direction of the mobile platform, and the moving speed of the mobile platform, where the target position has the first displacement distance away from the current position in the moving direction, and the first displacement distance is obtained by multiplying the movement speed and the designated period of time T1 and according to the target position, determine the predictive position information of the mobile platform, where the predictive position information includes the second position data used to characterize the target position.

In some embodiments, the mobile platform may predict the predictive position information once every period of time T2 and transmit the predictive position information obtained by the prediction to the base station, T2 being shorter than T1.

In some embodiments, the current positioning data may be measured and obtained by the positioning apparatus on the mobile platform or a positioning apparatus external to the mobile platform for positioning the mobile platform.

In some embodiments, the selection result may include a target cell information set. The target cell information set may include the cell information of the second cells.

When performing the measurement on the second cell according to the obtained selection result, the processor is configured to perform the measurement on the neighboring cell signal in the neighboring cell set of the first cell corresponding to the cell information of the target cell information set.

In some embodiments, the cell information includes at least a cell identity and a cell frequency point.

In some embodiments, when performing the measurement on the signal of the second cell according to the obtained selection result, the processor is configured to determine the second cell according to the obtained selection result and perform the measurement on the signal of the second cell.

In some embodiments, after performing the measurement on the signal of the second cell according to the obtained selection result, the processor is further configured to transmit the current measurement result of the second cells obtained by measuring the signal of the second cells to the base station so that the base station determines whether the mobile platform needs to perform the cell switch according to the current measurement result.

In some embodiments, the mobile platform may include a UAV or a handheld device.

For the specific content of the base station provided by the fifth aspect of the present disclosure, reference may be made to the related description in the neighboring cell signal measurement method provided by the first aspect of the present disclosure. The similarities are not repeated here.

A sixth aspect of the present disclosure provides a mobile platform. The mobile platform is configured to be in a first cell of a base station currently and includes a body, a power system, and one or more processors. The power system is configured to provide power to the body. The one or more processors are configured to transmit current positioning data of the mobile platform to a base station of the first cell so that the base station generates predictive position information according to the current positioning data, selects a second cell from neighboring cells of the first cell according to the predictive position information to obtain a selection result and transmit the selection result, and obtain the selection result transmitted from the base station and perform a measurement on a signal of the second cell according to the received selection result. The predictive position information includes predicted position information of the mobile platform at a designated period of time T1 after a current moment. The second cell is a cell that is to be measured by the mobile platform

In some embodiments, the mobile platform may include a UAV, or a handheld apparatus. The handheld apparatus may include, for example, a cellphone, a tablet, etc. The specific type of mobile platform is not limited. The mobile platform may further include another apparatus having a sim card, as long as the mobile platform have a function of communicating with the base station.

For example, the mobile platform may be the UAV. The body may be a UAV body. The power system may include a power source, a motor, and a propeller of the mobile platform. For another example, the mobile platform may be a cellphone. The body may be a cellphone body. The power system may be a power source on the mobile phone, and so on.

In some embodiments, when transmitting the current positioning data of the mobile platform to the base station of the first cell, the processor is configured to transmit the current positioning data every period of time T3, T3 being shorter than T1.

In some embodiments, the current positioning data may be measured and obtained by a positioning apparatus on the mobile platform or a positioning apparatus external to the mobile platform for positioning the mobile platform.

In some embodiments, the selection result may include a target cell information set. The target cell information set may include the cell information of the second cells.

When performing the measurement on the signal of the second cell according to the obtained selection result, the processor is configured to perform the measurement on the neighboring cell signal in the neighboring cell set of the first cell corresponding to the cell information in the target cell information set.

In some embodiments, the cell information may include at least a cell identity and a cell frequency point.

In some embodiments, when performing the measurement on the signal of the second cell according to the obtained selection result, the processor is configured to determine the second cell according to the obtained selection result and perform the measurement on the signal of the second cell.

In some embodiments, after performing the measurement on the signal of the second cell according to the obtained selection result, the processor is further configured to transmit the current measurement results of the second cells obtained by measuring the signals of the second cells to the base station so that the base station determines whether the mobile platform needs to perform the cell switch according to the current measurement result.

In some embodiments, the mobile platform may include a UAV or a handheld apparatus.

For the specific content of the base station provided by the sixth aspect of the present disclosure, reference may be made to the related description in the neighboring cell signal measurement method provided by the second aspect of the present disclosure. The similarities are not repeated here.

A seventh aspect of the present disclosure provides a neighboring cell signal measurement method. A mobile apparatus generates predictive position information according to current positioning data of the mobile platform and transmits the predictive position information to a base station, where the predictive position information includes predicted position information of the mobile platform at a designated period of time T1 after a current moment, and the mobile platform is currently located in a first cell of the base station. A base station obtains the predictive position information of the mobile platform and selects a second cell from neighboring cells of the predictive position information to obtain a selection result and transmit the selection result, where the second cell is a cell that is to be measured by the mobile platform. The mobile platform obtains the selection result transmitted by the base station and performs a measurement on a signal of the second cell according to the received selection result.

In some embodiments, the mobile platform may predict the predictive position information every period of time T2 and transmit the predictive position information obtained by the prediction to the base station. T2 may be shorter than T1.

In some embodiments, the current positioning data may include first position data that represents the current position of the mobile platform, the moving speed of the mobile platform, and the moving direction of the mobile platform.

Generating the predictive position information according to the current positioning data includes determining the target position of the mobile platform according to the first position data, the moving direction of the mobile platform, and the moving speed of the mobile platform, and according to the target position, determine the predictive position information of the mobile platform. The target position may have the first displacement distance away from the current position in the moving direction. The first displacement distance may be obtained by multiplying the movement speed and the designated period of time T1. The predictive position information includes second position data used to characterize the target position.

In some embodiments, the current positioning data may be measured and obtained by a positioning apparatus on the mobile platform or a positioning apparatus external to the mobile platform for positioning the mobile platform.

In some embodiments, selecting a second cell from the neighboring cells of the first cell according to the predictive position information includes predicting, according to the predictive position information, the target area where the mobile platform is located at the designated period of time T1 after the current moment and selecting the second cell from neighboring cells of the first cell according to the target area.

In some embodiments, the predictive position information may include second position data used to characterize the target position and a predetermined radius.

Predicting the target area where the mobile platform is located at the designated period of time T1 after the current moment according to the predictive position information includes according to the second position data and the predetermined radius, determining an area with the target position as the area center and the predetermined radius as the area radius and using the determined area as the target area.

In some embodiments, selecting the second cell from the neighboring cells of the first cell according to the target area includes determining the coverage area of the neighboring cells of the first cell and determining the second cell according to the coverage area of the neighboring cells of the first cell and the target area.

In some embodiments, determining the coverage area of the neighboring cells of the first cell includes obtaining a coverage area information set, the coverage area information set including the coverage area information of the neighboring cell set of the first cell, determining the coverage area information of the neighboring cells according to the coverage area information set as the target coverage area information of the neighboring cell set, and determining the coverage area of the neighboring cells according to the target coverage area information.

For each neighboring cell of the first cell, the target coverage area information of the neighboring cell may be determined from the obtained coverage area information set. The coverage area information set may include the coverage area information of all the neighboring cells of the first cell. The coverage area of the neighboring cells may be determined according to the target coverage area information.

In some embodiments, the target coverage area information may include third position data used to characterize the center position of the neighboring cell and a cell radius.

Determining the coverage area of the neighboring cell according to the target coverage area information includes according to the third position data and the cell radius, determining an area with the center position of the neighboring cell as the area center and the cell radius as the area radius and using the determined area as the coverage area of the neighboring cell.

In some embodiments, determining the second cell according to the coverage area of the neighboring cells of the first cell and the target area includes obtaining the moving direction of the mobile platform and determining the to be detected neighboring cell from the neighboring cells of the first cell according to the moving direction and for each to be detected neighboring cell, detecting whether the coverage area of the neighboring cell has an intersection with the target area, and if yes, determining the neighboring cell that has the intersection with the target area as the second cell.

In some embodiments, determining the second cell according to the coverage area of the neighboring cells of the first cell and the target area includes for each neighboring cell of the first cell, detecting whether the coverage area of the neighboring cell has an intersection with the target area, and if yes, determining the neighboring cell that has the intersection with the target area as the second cell.

In some embodiments, the selection result may include a target cell information set. The target cell information set may include the cell information of the second cells.

Before the base station transmits the selection result, the method further includes obtaining, by the base station, the cell information of the second cells from the obtained initial cell information set, where the initial cell information set includes the cell information of the neighboring cell set of the first cell and forming, by the base station, the obtained cell information of the second cells into the target cell information set.

In some embodiments, the mobile platform performing the measurement on the signal of the second cell according to the obtained selection result includes performing the measurement on the neighboring cell signal in the neighboring cell set of the first cell corresponding to the cell information in the target cell information set.

In some embodiments, the cell information may include at least a cell identity and a cell frequency point.

In some embodiments, the mobile platform performing the measurement on the signal of the second cell according to the obtained selection result includes the mobile platform determining the second cell according to the obtained selection result and performing the measurement on the signal of the second cell.

In some embodiments, after the base station transmits the selection result, the method further includes transmitting, by the mobile platform, the current measurement results of the second cells obtained by measuring the signals of the second cells to the base station, obtaining, by the base station, the current measurement results of the second cells obtained by the mobile platform measuring the signals of the second cells, and determining, by the base station, whether the mobile platform needs to perform the cell switch according to the current measurement results.

In some embodiments, determining whether the mobile platform needs to perform the cell switch according to the current measurement results includes:

traversing the current measurement results of the second cells;

detecting whether the signal strengths in the traversed current measurement result reaches the predetermined signal strength; and

if yes, obtaining N consecutive historical measurement results of the second cells measured before the mobile platform traverses the current measurement result, where N is greater than or equal to 1, obtaining the number of times that the signal strength in the N consecutive historical measurement results reach the predetermined signal strength, and determining whether the number of times that the signal strength in the N consecutive historical measurement results reaches the predetermined signal strength reaches the reference value, and if yes, determining that the mobile platform needs to perform the cell switch.

In one embodiment, the method further includes:

if the signal strength in the current measurement result of the second cell traversed by the base station reaches the predetermined signal strength, and if the signal strength in the historical measurement results of the second cell reaches the predetermined signal strength, determining that the mobile platform needs to perform the cell switch.

In some embodiments, after the base station determines that the mobile platform needs to perform the cell switch, the method further includes determining the second cell where the number of times that the signal strength in the N consecutive historical measurement results reaches the predetermined signal strength reaches the reference value and switching the mobile platform from the first cell to the determined second cell.

In some embodiments, the mobile platform may include a UAV or a handheld apparatus.

For the specific content of the base station provided by the seventh aspect of the present disclosure, reference may be made to the related description in the neighboring cell signal measurement method provided by the first, second, and third aspects of the present disclosure. The similarities are not repeated here.

An eighth aspect of the present disclosure provides a neighboring cell signal measurement method. A mobile platform transmits current positioning data of the mobile platform to a base station, a mobile apparatus being located in a first cell of the base station. The base station generates predictive position information according to current positioning data and selects a second cell from neighboring cells of the first cell according to the predictive position information to obtain a selection result and transmit the selection result. The predictive position information includes predicted position information of the mobile platform at a designated period of time T1 after a current moment. The second cell is a cell that is to be measured by the mobile platform. The mobile platform obtains the selection result transmitted by the base station and performs the measurement on a signal of the second cell according to the received selection result.

In some embodiments, the mobile platform transmits the current positioning data once every period of time T3, T3 being shorter than T1.

In some embodiments, the current positioning data may include first position data that characterizes the current position of the mobile platform, the moving speed of the mobile platform, and the moving direction of the mobile platform.

Generating the predictive position information according to the current positioning data includes determining the target position of the mobile platform according to the first position data, the moving direction of the mobile platform, and the moving speed of the mobile platform, and according to the target position, determine the predictive position information of the mobile platform. The target position has the first displacement distance away from the current position in the moving direction. The first displacement distance may be obtained by multiplying the movement speed and the designated period of time T1. The predictive position information includes second position data used to characterize the target position.

In some embodiments, the current positioning data may be measured and obtained by the positioning apparatus on the mobile platform or a positioning apparatus external to the mobile platform for positioning the mobile platform.

In some embodiments, selecting the second cell from the neighboring cells of the first cell according to the predictive position information includes predicting, according to the predictive position information, the target area where the mobile platform is located at the designated period of time T1 after the current moment and selecting the second cell from the neighboring cells of the first cell according to the target area.

In some embodiments, the predictive position information may include second position data used to characterize the target position and a predetermined radius.

predicting the target area where the mobile platform is located at the designated period of time T1 after the current moment according to the predictive position information includes according to the second position data and the predetermined radius, determining an area with the target position as the area center and the predetermined radius as the area radius and using the determined area as the target area.

In some embodiments, selecting the second cell from the neighboring cells of the first cell according to the target area includes determining the coverage area of the neighboring cells of the first cell and determining the second cell according to the coverage area of the neighboring cells of the first cell and the target area.

In some embodiments, determining, by the base station, the coverage area of the neighboring cell of the first cell includes obtaining a coverage area information set, determining the coverage area information of the neighboring cell according to the coverage area information set as the target coverage area information, and determining the coverage area of the neighboring cell according to the target coverage area information. The coverage area information set includes the coverage area information of the neighboring cell set of the first cell.

For each neighboring cell of the first cell, the target coverage area information of the neighboring cell may be determined from the obtained coverage area information set. The coverage area information set may include the coverage area information of all the neighboring cells of the first cell. The coverage area of the neighboring cells may be determined according to the target coverage area information.

In some embodiments, the target coverage area information may include third position data used to characterize the center position of the neighboring cell and a cell radius.

Determining the coverage area of the neighboring cell according to the target coverage area information includes according to the third position data and the cell radius, determining an area with the center position of the neighboring cell as the area center and the cell radius as the area radius and using the determined area as the coverage area of the neighboring cell.

In some embodiments, determining the second cell according to the coverage area of the neighboring cells of the first cell and the target area includes obtaining the moving direction of the mobile platform and determining the to be detected neighboring cell from the neighboring cells of the first cell according to the moving direction and for each to be detected neighboring cell, detecting whether the coverage area of the neighboring cell has an intersection with the target area, and if yes, determining the neighboring cell that has the intersection with the target area as the second cell.

In some embodiments, determining the second cell according to the coverage area of the neighboring cells of the first cell and the target area includes for each neighboring cell of the first cell, detecting whether the coverage area of the neighboring cell has the intersection with the target area, and if yes, determining the neighboring cell that has the intersection with the target area as the second cell.

In some embodiments, the selection result may include the target cell information set. The target cell information set may include the cell information of the second cells.

Before the base station transmits the selection result, the method further includes obtaining, by the base station, the cell information of the second cells from the obtained initial cell information set, and forming, by the base station, the obtained cell information of the second cells into the target cell information set. The initial cell information set includes the cell information of the neighboring cell set of the first cell.

In some embodiments, the mobile platform performing the measurement on the signal of the second cell according to the obtained selection result includes performing the measurement on the neighboring cell signal in the neighboring cell set of the first cell corresponding to the cell information in the target cell information set.

In some embodiments, the cell information may include at least a cell identity and a cell frequency point.

In some embodiments, the mobile platform performing the measurement on the signal of the second cell according to the obtained selection result includes the mobile platform determining the second cell according to the obtained selection result and performing the measurement on the signal of the second cell.

In some embodiments, after the base station transmits the selection result, the method further includes transmitting, by the mobile platform, the current measurement result of the second cells obtained by measuring the signals of the second cells to the base station, obtaining, by the base station, the current measurement results of the second cells obtained by the mobile platform measuring the signals of the second cells, and determining, by the base station, whether the mobile platform needs to perform the cell switch according to the current measurement result.

In some embodiments, determining whether the mobile platform needs to perform the cell switch according to the current measurement result includes:

traversing the current measurement results of the second cells;

detecting whether the signal strengths in the traversed current measurement result reaches the predetermined signal strength; and

if yes, obtaining N consecutive historical measurement results of the second cells measured before the mobile platform traverses the current measurement result, where N is greater than or equal to 1, obtaining the number of times that the signal strength in the N consecutive historical measurement results reach the predetermined signal strength, and determining whether the number of times that the signal strength in the N consecutive historical measurement results reaches the predetermined signal strength reaches the reference value, and if yes, determining that the mobile platform needs to perform the cell switch.

In some embodiments, the method further includes if the signal strength in the current measurement result of the second cell traversed by the base station reaches the predetermined signal strength, and if all the signal strengths in the historical measurement results of the second cell are detected to reach the predetermined signal strength, determining that the mobile platform needs to perform the cell switch.

In some embodiments, after the base station determines that the mobile platform needs to perform the cell switch, the method further includes determining the second cell where the number of times that the signal strengths in the N consecutive historical measurement results reach the predetermined signal strength reaches the reference value and switching the mobile platform from the first cell to the determined second cell.

In some embodiments, the mobile platform may include a UAV or a handheld apparatus.

For the specific content of the base station provided by the eighth aspect of the present disclosure, reference may be made to the related description in the neighboring cell signal measurement method provided by the first, second, and third aspects of the present disclosure. The similarities are not repeated here.

A ninth aspect of the present disclosure provides a measurement system of a neighboring cell signal, including a mobile platform and a base station. The mobile platform is configured to be in a first cell of the base station currently.

The mobile platform is configured to generate predictive position information according to current positioning data of the mobile platform and transmit the predictive position information to the base station to obtain a selection result transmitted by the base station and perform a measurement on a signal of a second cell according to the received selection result. The predictive position information includes predicted position information of the mobile platform at a designated period of time T1 after a current moment.

The base station is configured to obtain the predictive position information of the mobile platform and select the second cell from neighboring cells of the first cell according to the predictive position information to obtain the selection result and transmit the selection result. The second cell is a cell that is to be measured by the mobile platform.

In some embodiments, the mobile platform may predict the predictive position information once every period of time T2 and transmit the predictive position information obtained by the prediction to the base station. T2 is shorter than T1.

In some embodiments, the current positioning data may include the first position data that characterizes the current position of the mobile platform, the moving speed of the mobile platform, and the moving direction of the mobile platform.

When generating the predictive position information according to the current positioning data, the mobile apparatus is configured to determine the target position of the mobile platform according to the first position data, the moving direction of the mobile platform, and the moving speed of the mobile platform, and according to the target position, determine the predictive position information of the mobile platform. The target position has the first displacement distance away from the current position in the moving direction. The first displacement distance is obtained by multiplying the movement speed and the designated period of time T1. The predictive position information includes second position data used to characterize the target position.

In some embodiments, the current positioning data may be measured and obtained by a positioning apparatus on the mobile platform a positioning apparatus external to the mobile platform for positioning the mobile platform.

In some embodiments, when selecting the second cell from the neighboring cells of the first cell according to the predictive position information, the base station is configured to predict, according to the predictive position information, the target area where the mobile platform is located at the designated period of time T1 after the current moment and select the second cell from the neighboring cells of the first cell according to the target area.

In some embodiments, the predictive position information may include second position data used to characterize the target position and a predetermined radius.

When predicting the target area where the mobile platform is located at the designated period of time T1 after the current time according to the predictive position information, the base station is configured to according to the second position data and the predetermined radius, determine an area with the target position as the area center and the predetermined radius as the area radius and use the determined area as the target area.

In some embodiments, when selecting the second cell from the neighboring cells of the first cell according to the target area, the base station is configured to determine the coverage area of the neighboring cells of the first cell and determine the second cell according to the coverage area of the neighboring cells of the first cell and the target area.

In some embodiments, when determining the coverage area of the neighboring cell of the first cell, the base station is configured to obtain the coverage area information set, determine the coverage area information of the neighboring cell according to the coverage area information set as the target coverage area information, and determine the coverage area of the neighboring cell according to the target coverage area information. The coverage area information set includes the coverage area information of the neighboring cell set of the first cell.

For each neighboring cell of the first cell, the target coverage area information of the neighboring cell may be determined from the obtained coverage area information set. The coverage area information set may include the coverage area information of the neighboring cell set of the first cell. The coverage area of the neighboring cell may be determined according to the target coverage area information.

In some embodiments, the target coverage area information may include third position data used to characterize the center position of the neighboring cell and a cell radius.

When determining the coverage area of the neighboring cell according to the target coverage area information, the base station is configured to according to the third position data and the cell radius, determine an area with the center position of the neighboring cell as the area center and the cell radius as the area radius and use the determined area as the coverage area of the neighboring cell.

In some embodiments, when determining the second cell according to the coverage area of the neighboring cells of the first cell and the target area, the base station is configured to obtain the moving direction of the mobile platform and determine the to be detected neighboring cell from the neighboring cells of the first cell according to the moving direction and, for each to be detected neighboring cell, detect whether the coverage area of the neighboring cell has an intersection with the target area, and if yes, determine the neighboring cell that has the intersection with the target area as the second cell.

In some embodiments, when determining the second cell according to the coverage area of neighboring cells of the first cell and the target area, the base station is configured to for each neighboring cell of the first cell, detect whether the coverage area of the neighboring cell has the intersection with the target area, and if yes, determine the neighboring cell that has the intersection with the target area as the second cell.

In some embodiments, the selection result may include the target cell information set. The target cell information set may include the cell information of the second cells.

Before transmitting the selection result, the base station is further configured to obtain the cell information of the second cells from the obtained initial cell information set, and form the obtained cell information of the second cells into the target cell information set. The initial cell information set includes the cell information of the neighboring cell set of the first cell.

In some embodiments, when performing the measurement on the signal of the second cell according to the obtained selection result, the mobile platform is configured to perform the measurement on the neighboring cell signal in the neighboring cell set of the first cell corresponding to the cell information in the target cell information set.

In some embodiments, the cell information may include at least a cell identity and a cell frequency point.

In some embodiments, when performing the measurement on the signal of the second cell according to the obtained selection result, the mobile platform is configured to determine the second cell according to the obtained selection result and perform the measurement on the signal of the second cell.

In some embodiments, the mobile platform is further configured to transmit the current measurement results of the second cells obtained by measuring the signals of the second cells to the base station.

The base station is further configured to obtain the current measurement results of the second cells obtained by the mobile platform measuring the signals of the second cells and determine whether the mobile platform needs to perform the cell switch according to the current measurement results.

In some embodiments, when determining whether the mobile platform needs to perform the cell switch according to the current measurement result, the base station is configured to:

traverse the current measurement results of the second cells;

detect whether the signal strengths in the traversed current measurement result reaches the predetermined signal strength; and

if yes, obtain N consecutive historical measurement results of the second cells measured before the mobile platform traverses the current measurement result, where N is greater than or equal to 1, obtain the number of times that the signal strength in the N consecutive historical measurement results reach the predetermined signal strength, and determine whether the number of times that the signal strength in the N consecutive historical measurement results reaches the predetermined signal strength reaches the reference value, and if yes, determine that the mobile platform needs to perform the cell switch.

In some embodiments, the base station is further configured to if the signal strengths in the traversed current measurement result of the second cell reach the predetermined signal strength, and if the signal strengths in the historical measurement results of the second cells are detected to reach the predetermined signal strength, determine that the mobile platform needs to perform the cell switch.

In some embodiments, after determining that the mobile platform needs to perform the cell switch, the base station is further configured to determine the second cell where the number of times that the signal strengths in the N consecutive historical measurement results reach the predetermined signal strength reaches the reference value and switch the mobile platform from the first cell to the determined second cell.

In some embodiments, the mobile platform may include a UAV or a handheld apparatus.

For the specific content of the base station provided by the nineth aspect of the present disclosure, reference may be made to the related description in the neighboring cell signal measurement method provided by the first, second, and third aspects of the present disclosure. The similarities are not repeated here.

A tenth aspect of the present disclosure provides a measurement system of a neighboring cell signal, including a mobile platform and a base station. The mobile platform is configured to be in a first cell of the base station currently.

The mobile platform is configured to transmit current positioning data of the mobile platform to the base station, obtain a selection result transmitted by the base station, and perform a measurement on a signal of a second cell according to the received selection result.

The base station is configured to generate predictive position information according to the obtained current positioning data and select the second cell from neighboring cells of the first cell according to the predictive position information to obtain the selection result and transmit the selection result. The predictive position information includes predicted position information of the mobile platform at a designated period of time T1 after a current moment. The second cell is a cell that is to be measured by the mobile platform.

In some embodiments, the mobile platform may transmit the current positioning data once every period of time T3. T3 is shorter than T1.

In some embodiments, the current positioning data may include the first position data that characterizes the current position of the mobile platform, the moving speed of the mobile platform, and the moving direction of the mobile platform.

When generating the predictive position information according to the current positioning data, the base station is configured to determine the target position of the mobile platform according to the first position data, the moving direction of the mobile platform, and the moving speed of the mobile platform and according to the target position, determine the predictive position information of the mobile platform. The target position has the first displacement distance away from the current position in the moving direction. The first displacement distance is obtained by multiplying the movement speed and the designated period of time T1. The predictive position information includes the second position data used to characterize the target position.

In some embodiments, the current positioning data may be measured and obtained by a positioning apparatus on the mobile platform or a positioning apparatus external to the mobile platform for positioning the mobile platform.

In some embodiments, when selecting the second cell from the neighboring cells of the first cell according to the predictive position information, the base station is configured to predict, according to the predictive position information, the target area where the mobile platform is located at the designated period of time T1 after the current moment and select the second cell from the neighboring cells of the first cell according to the target area.

In some embodiments, the predictive position information may include second position data used to characterize the target position and a predetermined radius.

When predicting the target area where the mobile platform is located at the designated period of time T1 after the current moment according to the predictive position information, the base station is configured to according to the second position data and the preset radius, determine an area with the target position as the area center and the predetermined radius as the area radius and use the determined area as the target area.

In some embodiments, when selecting the second cell from the neighboring cells of the first cell according to the target area, the base station is configured to determine the coverage area of the neighboring cells of the first cell and determine the second cell according to the coverage area of the neighboring cells of the first cell and the target area.

In some embodiments, when determining the coverage area of the neighboring cells of the first cell, the base station is configured to obtain the coverage area information set, determine the coverage area information of the neighboring cells according to the coverage area information set as the target coverage area information, and determine the coverage area of the neighboring cells according to the target coverage area information. The coverage area information set includes the coverage area information of the neighboring cell set of the first cell.

For each neighboring cell of the first cell, the target coverage area information of the neighboring cell may be determined from the obtained coverage area information set. The coverage area information set may include the coverage area information of the neighboring cell set of the first cell. The coverage area of the neighboring cell may be determined according to the target coverage area information.

In some embodiments, the target coverage area information may include third position data used to characterize the center position of the neighboring cell and a cell radius.

When determining the coverage area of the neighboring cells according to the target coverage area information, the base station is configured to according to the third position data and the cell radius, determine an area with the center position of the neighboring cell as the area center and the cell radius as the area radius and use the determined area as the coverage area of the neighboring cell.

In some embodiments, when determining the second cell according to the coverage area of the neighboring cells of the first cell and the target area, the base station is configured to obtain the moving direction of the mobile platform and determine the to be detected neighboring cell from the neighboring cells of the first cell according to the moving direction and for each to be detected neighboring cell, detect whether the coverage area of the neighboring cell has an intersection with the target area, and if yes, determine the neighboring cell that has the intersection with the target area as the second cell.

In some embodiments, when determining the second cell according to the coverage area of neighboring cells of the first cell and the target area, the base station is configured to for each neighboring cell of the first cell, detect whether the coverage area of the neighboring cell has the intersection with the target area, and if yes, determine the neighboring cell that has the intersection with the target area as the second cell.

In some embodiments, the selection result may include the target cell information set. The target cell information set may include the cell information of the second cells.

Before transmitting the selection result, the base station is further configured to obtain the cell information of the second cells from the obtained initial cell information set and form the obtained cell information of the second cells into the target cell information set. The initial cell information set includes the cell information of the neighboring cell set of the first cell.

In some embodiments, when performing the measurement on the signal of the second cell according to the obtained selection result, the mobile platform is configured to perform the measurement on the neighboring cell signal in the neighboring cell set of the first cell corresponding to the cell information in the target cell information set.

In some embodiments, the cell information may include at least a cell identity and a cell frequency point.

In some embodiments, when performing the measurement on the signal of the second cell according to the obtained selection result, the mobile platform is configured to determine the second cell according to the obtained selection result and perform the measurement on the signal of the second cell.

In some embodiments, the mobile platform is further configured to transmit the current measurement results of the second cells obtained by measuring the signals of the second cells to the base station.

The base station is further configured to obtain the current measurement results of the second cells obtained by the mobile platform measuring the signals of the second cells and determine whether the mobile platform needs to perform the cell switch according to the current measurement results.

In some embodiments, when determining whether the mobile platform needs to perform the cell switch according to the current measurement result, the base station is configured to:

traverse the current measurement results of the second cells;

detect whether the signal strengths in the traversed current measurement result reaches the predetermined signal strength; and

if yes, obtain N consecutive historical measurement results of the second cells measured before the mobile platform traverses the current measurement result, where N is greater than or equal to 1, obtain the number of times that the signal strength in the N consecutive historical measurement results reach the predetermined signal strength, and determine whether the number of times that the signal strength in the N consecutive historical measurement results reaches the predetermined signal strength reaches the reference value, and if yes, determine that the mobile platform needs to perform the cell switch.

In some embodiments, the base station is further configured to if the signal strengths in the traversed current measurement result of the second cell reach the predetermined signal strength, and if all the signal strengths in the historical measurement results of the second cells are detected to reach the predetermined signal strength, determine that the mobile platform needs to perform the cell switch.

In some embodiments, after determining that the mobile platform needs to perform the cell switch, the base station is further configured to determine the second cell where the number of times that the signal strengths in the N consecutive historical measurement results reach the predetermined signal strength reaches the reference value and switch the mobile platform from the first cell to the determined second cell.

In some embodiments, the mobile platform may include a UAV or a handheld apparatus.

For the specific content of the base station provided by the tenth aspect of the present disclosure, reference may be made to the related description in the neighboring cell signal measurement method provided by the first, second, and third aspects of the present disclosure. The similarities are not repeated here.

Based on the same inventive concept as the above method, embodiments of the present disclosure further provide a computer-readable storage medium storing computer instructions. When the computer instructions are executed (e.g., when the computer instructions are executed by a processor), the neighboring cell signal measurement method of the above embodiments may be realized.

The systems, devices, modules, or units explained in the above embodiments may be implemented by computer chips or entities or implemented by a product with a certain function. A typical implementation apparatus may include a computer. The specific form of the computer may include a personal computer, a laptop computer, a cellular phone, a camera phone, a smartphone, a personal digital assistant, a media player, a navigation apparatus, an email receiving and sending apparatus, and a game console, a tablet computer, a wearable apparatus, or a combination of any of the apparatuses thereof.

To facilitate the description, when the above device is described, the functions may be divided into various units and described separately. When the present disclosure is implemented, the functions of the units may be implemented in a same or more pieces of software and/or hardware.

Those skilled in the art should understand that embodiments of the present disclosure may be provided as a method, a system, or a computer program product. Therefore, the present disclosure may adopt forms of a complete hardware embodiment, a complete software embodiment, or an embodiment combining software and hardware. Moreover, embodiments of the present disclosure may adopt one or more computer-readable storage media (including but not limited to disk storage, CD-ROM, optical storage, etc.) including the computer-usable program codes.

The present disclosure may be described with reference to flowcharts and/or block diagrams of the methods, the apparatuses (systems), and the computer program products according to embodiments of the present disclosure. Each process and/or block in the flowchart and/or block diagram and the combination of processes and/or blocks in the flowchart and/or block diagram may be realized by the computer program instructions. These computer program instructions may be provided to processors of a general-purpose computer, a special-purpose computer, an embedded processor, or another programmable data processing apparatus to generate a machine so that the instructions executed by the processors of the computer or the another programmable data processing apparatus may generate a device configured to realize the designated functions of one or more processes in the flowchart and/or one or more blocks in the block diagram.

Moreover, these computer program instructions may also be stored in the computer-readable memory that can guide the computer or the another programmable data processing apparatus to work in a specific manner. Thus, the instructions stored in the computer-readable memory may generate a product including an instruction device. The instruction device may realize the functions specified in one or more processes in the flowchart and/or one or more blocks in the block diagram.

These computer program instructions may also be loaded into the computer or the another programmable data processing apparatus, so that a series of operation steps may be executed on the computer or the another programmable apparatus to generate computer-implemented processing. Thus, the instructions executed on the computer or the another programmable apparatus may provide steps for realizing the functions specified in one or more processes in the flowchart and/or one or more blocks in the block diagram.

The above description is merely some embodiments of the present disclosure and is not used to limit the present disclosure. For those skilled in the art, the present disclosure may have various modifications and changes. Any modifications, equivalent replacements, and improvements made within the spirit and principle of the present disclosure should be within the scope of the present disclosure.

What is claimed is:

1. A neighboring cell signal measurement method comprising:
obtaining predictive position information of a mobile platform in a first cell, the predictive position information including predicted position information of the mobile platform at a period of time after a current moment;
selecting a second cell from neighboring cells of the first cell according to the predictive position information to obtain a selection result; and
transmitting the selection result to the mobile platform so that the mobile platform performs measurement on a signal of the second cell according to the selection result.

2. The measurement method of claim 1, wherein:
the period of time is a first period of time; and
obtaining the predictive position information of the mobile platform includes: obtaining the predictive position information once every second period of time, the second period of time being shorter than the first period of time.

3. The measurement method of claim 1, wherein obtaining the predictive position information of the mobile platform includes:
obtaining current positioning data of the mobile platform; and
generating the predictive position information according to the current positioning data.

4. The measurement method of claim 3, wherein:
the current positioning data includes first position data that represents a current position of the mobile platform, a moving speed of the mobile platform, and a moving direction of the mobile platform; and
generating the predictive position information according to the current positioning data includes:
determining a target position of the mobile platform according to the first position data, the moving direction of the mobile platform, and the moving speed of the mobile platform, the target position having a displacement distance away from the current position in the moving position, and the displacement distance being obtained by multiplying the moving speed and the period of time; and
determining the predictive position information of the mobile platform according to the target position, the predictive position information including second position data representing the target position.

5. The measurement method of claim 3, wherein:
the period of time is a first period of time; and
obtaining the current positioning data of the mobile platform includes obtaining the current positioning data once every second period of time, the second period of time being shorter than the first period of time.

6. The measurement method of claim 3, wherein:
the current positioning data is measured by a positioning apparatus of the mobile platform or a positioning apparatus external to the mobile platform.

7. The measurement method of claim 1, wherein selecting the second cell from the neighboring cells of the first cell according to the predictive position information includes:
predicting a target area in which the mobile platform is located at the period of time after the current moment according to the predictive position information; and
selecting the second cell from the neighboring cells of the first cell according to the target area.

8. The measurement method of claim 7, wherein:
the predictive position information includes position data representing a target position and a predetermined radius; and
predicting the target area includes:
according to the position data and the predetermined radius, determining an area with the target position as an area center and the predetermined radius as an area radius and using the determined area as the target area.

9. The measurement method of claim 7, wherein selecting the second cell from the neighboring cells of the first cell according to the predictive position information includes:
determining a coverage area of the neighboring cells of the first cell; and
determining the second cell according to the coverage area of the neighboring cells of the first cell and the target area.

10. The measurement method of claim 9, wherein determining the coverage area of the neighboring cells of the first cell includes:
obtaining a coverage area information set;
determining coverage area information of the neighboring cells according to the coverage area information set as target coverage area information; and
determining a coverage area of one neighboring cell of the neighboring cells according to the target coverage area information.

11. The measurement method of claim 10, wherein:
the target coverage area information includes position data representing a center position of the one neighboring cell and a cell radius; and
determining the coverage area of the one neighboring cell according to the target coverage area information includes:
according to the position data and the cell radius, determining an area with the center position of the one neighboring cell as an area center and the cell radius as an area radius and using the determined area as the coverage area of the one neighboring cell.

12. The measurement method of claim 9, wherein determining the second cell according to the coverage area of the neighboring cells of the first cell and the target area includes:
obtaining a moving direction of the mobile platform;
determining a to-be-detected neighboring cell from the neighboring cells of the first cell according to the moving direction;
detecting whether a coverage area of the to-be-detected neighboring cell overlap the target area; and
determining the to-be-detected neighboring cell as the second cell in response to the coverage area of the to-be-detected neighboring cell overlapping the target area.

13. The measurement method of claim 9, wherein determining the second cell according to the coverage area of the neighboring cells of the first cell and the target area includes:
for each neighboring cell of the first cell, detecting whether a coverage area of the neighboring cell overlaps the target area, and in response to the coverage area of the neighboring cell overlapping the target area, determining the neighboring cell as the second cell.

14. The measurement method of claim 1,
wherein the selection result includes a target cell information set, the target cell information set including cell information of the second cell;
the method further comprising, before transmitting the selection result to the mobile platform:
obtaining the cell information of the second cell from initial cell information set, the initial cell information set including cell information of the neighboring cells of the first cell; and
forming the target cell information set using the obtained cell information of the second cell.

15. The measurement method of claim 14, wherein the cell information at least includes a cell identity and a cell frequency point.

16. The measurement method of claim 1, wherein performing the measurement on the signal of the second cell according to the obtained selection result includes:
determining the second cell according to the obtained selection result and performing the measurement on the signal of the second cell.

17. The measurement method of claim 1, further comprising, after transmitting the selection result to the mobile platform:
obtaining a current measurement result of the second cell obtained by the mobile platform measuring the signal of the second cell; and
determining whether the mobile platform needs to perform cell switch according to the current measurement result.

18. The measurement method of claim 17, wherein determining whether the mobile platform needs to perform the cell switch according to the current measurement result includes:
traversing the current measurement result of the second cell;
detecting whether a signal strength in the current measurement result reaches a predetermined signal strength; and
in response to determining that the signal strength in the current measurement result reaching the predetermined signal strength:
obtaining one or more consecutive historical measurement results of the second cell measured before the mobile platform traverses the current measurement result;
obtaining a number of times when a signal strength in one of the one or more consecutive historical measurement results reaches the predetermined signal strength;
determining whether the number of times reaches a reference value; and
determining that the mobile platform needs to perform the cell switch in response to determining that the number of times reaches the reference value.

19. A neighboring cell signal measurement method comprising:
generating predictive position information according to current positioning data of a mobile platform in a first cell of a base station, the predictive position information including predicted position information of the mobile platform at a period of time after a current moment;
transmitting the predictive position information to the base station so that the base station selects a second cell from neighboring cells of the first cell according to the received predictive position information to obtain a selection result;
obtaining the selection result transmitted by the base station; and
performing measurement on a signal of the second cell according to the selection result.

20. A neighboring cell signal measurement method comprising:
transmitting current positioning data of a mobile platform in a first cell to a base station associated with the first cell so that the base station generates predictive position information according to the current positioning data and selects a second cell from neighboring cells of the first cell according to the predictive position information to obtain a selection result, the predictive position information including predicted position information of the mobile platform at a period of time after a current moment;
obtaining the selection result transmitted from the base station; and
performing measurement on a signal of the second cell according to the received selection result.
